(19) United States
(12) Patent Application Publication
(10) Pub. No.: US 2026/0205243 A1
(43) Pub. Date: Jul. 16, 2026

(54) PRS AND SRS AGGREGATION IN POSITIONING TRANSMISSIONS

(71) Applicant: QUALCOMM Incorporated, San Diego, CA (US)

(72) Inventors: Alexandros MANOLAKOS, Athens (GR); Sony AKKARAKARAN, Poway, CA (US); Carlos CABRERA MERCADER, Cardiff, CA (US)

(21) Appl. No.: 19/139,309

(22) PCT Filed: Jan. 22, 2024
(86) PCT No.: PCT/US2024/012445

§ 371 Date: Jun. 13, 2025

(30) Foreign Application Priority Data
Feb. 13, 2023 (GR) 20230100108

(51) Int. Cl. H04L 5/00

(52) U.S. Cl. CPC H04L 5/0048

(57) ABSTRACT

Apparatuses and methods for PRS/SRS aggregation in positioning transmissions are described. An apparatus is configured to receive an aggregation configuration indicating SRS resources for aggregation in UL transmissions, and to transmit, based on the aggregation configuration, a pilot signal via the SRS resources. The SRS resources are aggregated with a coherency property in a same set of OFDM symbols, and the at least two SRS resources are associated with a same pathloss parameter, transmit power spectral density spatial relation reference signal, comb size, and/or time-domain characteristic. Another apparatus is configured to receive an aggregation configuration indicating PRS resources to be aggregated in a DL transmission, and to receive, from a network entity, a pilot signal via the PRS resources. The PRS resources are aggregated with a coherency property. A PRS resource is associated with a TxTEG identifier based on assistance information indicating another PRS resource is assigned the TxTEG identifier.

### CROSS-REFERENCE TO RELATED APPLICATION

This application claims the benefit of Greece Patent Application Serial No. 20230100108, entitled “PRS AND SRS AGGREGATION IN POSITIONING TRANSMISSIONS” and filed on Feb. 13, 2023, which is expressly incorporated by reference herein in its entirety.

### TECHNICAL FIELD

The present disclosure relates generally to communication systems, and more particularly, to wireless communications utilizing positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network node, an aggregation configuration that indicates at least two sounding reference signal (SRS) resources to be aggregated in an uplink (UL) transmission. The apparatus is also configured to transmit, based on the aggregation configuration, at least one pilot signal via the at least two SRS resources, where the at least two SRS resources are aggregated with a coherency property in a same set of orthogonal frequency division multiplexing (OFDM) symbols, where the at least two SRS resources are associated with at least one of a same pathloss parameter, a same transmit power spectral density, a same spatial relation reference signal, a same comb size, and/or at least one same time-domain characteristic.

In the aspect, the method includes receiving, from a network node, an aggregation configuration that indicates at least two SRS resources to be aggregated in an UL transmission. The method also includes transmitting, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, and/or at least one same time-domain characteristic.

In another aspect of the disclosure, a method, a computer-readable medium, and an apparatus are provided. The apparatus is configured to receive, from a network node, an aggregation configuration that indicates at least two positioning reference signal (PRS) resources to be aggregated in a downlink (DL) transmission. The apparatus is also configured to receive, from a network entity based on the aggregation configuration, at least one pilot signal via the at least two PRS resources, where the at least two PRS resources are aggregated with a coherency property, where a second PRS resource of the at least two PRS resources is associated with a transmission timing error group (TxTEG) identifier, in an absence of an assignment of the TxTEG identifier to the second PRS resource, based on assistance information that indicates a first PRS resource of the at least two PRS resources is assigned to the TxTEG identifier.

In the aspect, the method includes receiving, from a network node, an aggregation configuration that indicates at least two PRS resources to be aggregated in a DL transmission. The method also includes receiving, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of UE positioning based on reference signal measurements.

FIG. 5 shows examples of call flow diagrams and configurations for wireless communications, in accordance with various aspects of the present disclosure.

FIG. 6 shows examples of configurations for wireless communications, in accordance with various aspects of the present disclosure.

FIG. 7 shows example block diagrams and configurations for wireless communications, in accordance with various aspects of the present disclosure.

FIG. 8 shows example configurations for wireless communications, in accordance with various aspects of the present disclosure.

FIG. 9 is a call flow diagram for wireless communications, in accordance with various aspects of the present disclosure.

FIG. 10 shows example configurations for coherency status indications and transmission timing error margin for SRS/PRS resources, in accordance with various aspects of the present disclosure.

FIG. 11 is a call flow diagram for wireless communications, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

FIG. 18 is a diagram illustrating an example of a hardware implementation for an example network entity.

### DETAILED DESCRIPTION

Wireless communication networks, such as a 5G NR network, may enable positioning measurements and operations to locate wireless devices. For example, a wireless communication network may utilize pilot signals transmitted via reference signal resources such as sounding reference signal (SRS) resources and/or positioning reference signal (PRS) resources. Such reference signal resources may have characteristics such as transmission timing error group (TxTEG) identifiers, transmission timing error margins, transmission timing errors, and/or the like. To improve efficiency in positioning measurements and operations, reference signal resources may be aggregated for transmissions.

However, coherency for transmissions of aggregated reference signal resources may affect accuracy in positioning information and operations. A UE may not be aware of a loss of coherency for aggregated reference signal resources until after the transmission via aggregated reference signal resources has occurred. Thus, accuracy for timing and positioning at the network side may be impacted. Moreover, signaling overhead for reference signal resource characteristics (e.g., TxTEG identifiers, transmission timing error margins, transmission timing errors, etc.) may include additional processing (e.g., encoding/decoding) and power consumption for transmitters and receivers.

Various aspects relate generally to wireless communications systems and positioning operations for wireless devices. Some aspects more specifically relate to aggregation of SRS and PRS resources in positioning transmissions. In one example, a UE may receive an aggregation configuration that indicates at least two SRS resources to be aggregated in an UL transmission, and may transmit, based on the aggregation configuration, at least one pilot signal via the at least two SRS resources. The at least two SRS resources may be aggregated with a coherency property in a same set of OFDM symbols, and the at least two SRS resources may be associated with at least one of a same pathloss parameter, a same transmit power spectral density, a same spatial relation reference signal, a same comb size, and/or at least one same time-domain characteristic. The same pathloss parameter may be associated with a cross-component carrier (CC) pathloss reference indication, and the at least two SRS resources may be transmitted with the cross-CC pathloss reference indication, the same pathloss parameter may be associated with a CC with a lowest CC index, and/or the same pathloss parameter may be associated with a CC that is a Pcell for the UE. In another example, a UE may receive, from a network node, an aggregation configuration that indicates at least two PRS resources to be aggregated in a DL transmission, and may receive, from a network entity (e.g., a location management function (LMF)) based on the aggregation configuration, at least one pilot signal via the at least two PRS resources. The at least two PRS resources may be aggregated with a coherency property, and a second PRS resource of the at least two PRS resources may be associated with a TxTEG identifier, in an absence of an assignment of the TxTEG identifier to the second PRS resource, based on assistance information that indicates a first PRS resource of the at least two PRS resources is assigned to the TxTEG identifier.

Particular aspects of the subject matter described in this disclosure can be implemented to realize one or more of the following potential advantages. In some examples, by reporting coherency status information via indications for aggregated reference signal resources and associating TxTEG identifiers and timing error margins to unassigned or untagged reference signal resources, the described techniques can be used to more efficiently transmit signals on reference signal resources, improving bandwidth and supporting cross-CC pathloss reference indications for intra-band aggregation, while reducing signaling overhead for TxTEG identifiers and timing error margins, as well as providing network nodes (e.g., base stations) and network entities (e.g., LMFs) coherency status information via indications for aggregated reference signal resources maintaining and/or losing coherency. Additionally, by providing configurations for improved granularity for timing reporting, e.g., for receive-transmit time differences, the described techniques can be used to improve precision in timing measurements/reporting, and by extending associations of characteristics for aggregated resources to aggregations in positioning frequency layers (PFLs), the described techniques can be used to improve reference signal time difference (RSTD) and UE reception-transmission (RxTx) time difference measurements and reduce signaling overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

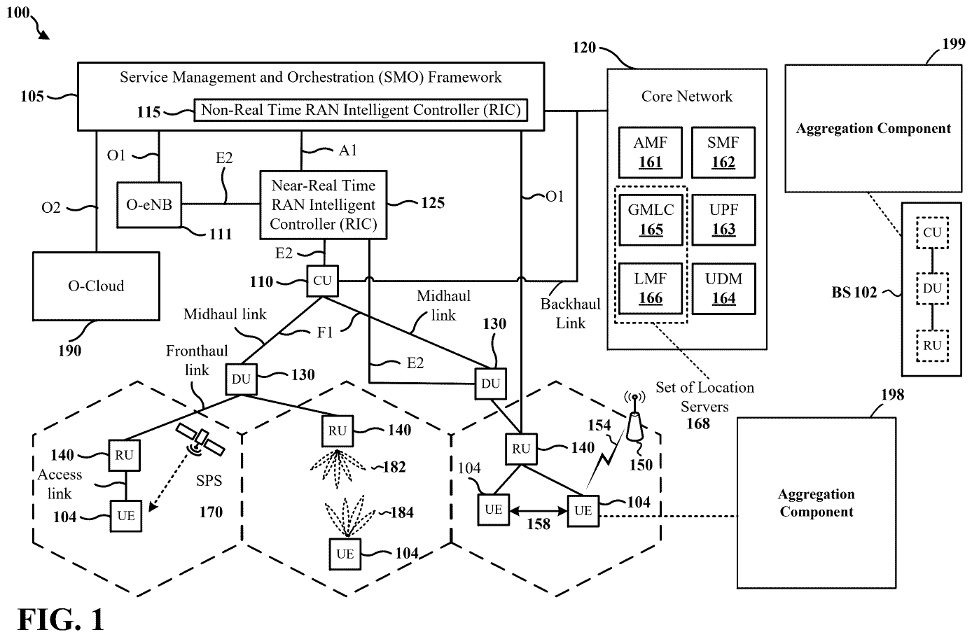

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an aggregation component 198 (“component 198”) that may be configured to receive, from a network node, an aggregation configuration that indicates at least two SRS resources to be aggregated in an UL transmission. The component 198 may be configured to transmit, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, and/or at least one same time-domain characteristic. The component 198 may also be configured to transmit at least one additional pilot signal via an additional instance of the at least two SRS resources. The component 198 may be configured to obtain a coherency indication that indicates the additional instance of the at least two SRS resources has a loss of coherency or a maintenance of coherency. The component 198 may be configured to transmit a coherency status indication that includes information associated with the loss of coherency or the maintenance of coherency for the additional instance of the at least two SRS resources. The component 198 may be configured to transmit a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In certain aspects, the component 198 may be configured to receive, from a network node, an aggregation configuration that indicates at least two PRS resources to be aggregated in a DL transmission. The component 198 may be configured to receive, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. The component 198 may also be configured to process the first PRS resource and the second PRS resource of the at least two PRS resources according to the TxTEG identifier in the absence of the assignment of the TxTEG identifier to the second PRS resource. The component 198 may also be configured to transmit measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. In certain aspects, the base station 102 may have an aggregation component 199 (“component 199”) that may be configured to transmit, for a UE, an aggregation configuration that indicates at least two SRS resources to be aggregated in an UL transmission. The component 199 may be configured to receive, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, and/or at least one same time-domain characteristic. The component 199 may also be configured to receive at least one additional pilot signal via an additional instance of the at least two SRS resources. The component 199 may be configured to receive a coherency status indication that includes information associated with the loss of coherency or the maintenance of coherency for the additional instance of the at least two SRS resources. The component 199 may be configured to receive a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In certain aspects, the component 199 may be configured to transmit, for a UE, an aggregation configuration that indicates at least two PRS resources to be aggregated in a DL transmission. The component 199 may be configured to transmit, as an instance of and from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. The component 199 may also be configured to receive measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. That is, aspects provide for aggregation of SRS and PRS resources in positioning transmissions that enables more efficient transmission of signals on reference signal resources, improving bandwidth and supporting cross-CC pathloss reference indications for intra-band aggregation, while reducing signaling overhead for TxTEG identifiers and timing error margins, as well as providing network nodes (e.g., base stations) and network entities (e.g., LMFs) coherency status information via indications for aggregated reference signal resources maintaining and/or losing coherency, by reporting indications of coherency status information for aggregated reference signal resources and associating TxTEG identifiers and timing error margins to unassigned or untagged reference signal resources. Additionally, improved precision in timing measurements/reporting is provided by providing configurations for improved granularity for timing reporting, e.g., for receive-transmit time differences, and the improved RSTD and UE RxTx time difference measurements and reduced signaling overhead is provided by extending associations of characteristics for aggregated resources to aggregations in PFLs.

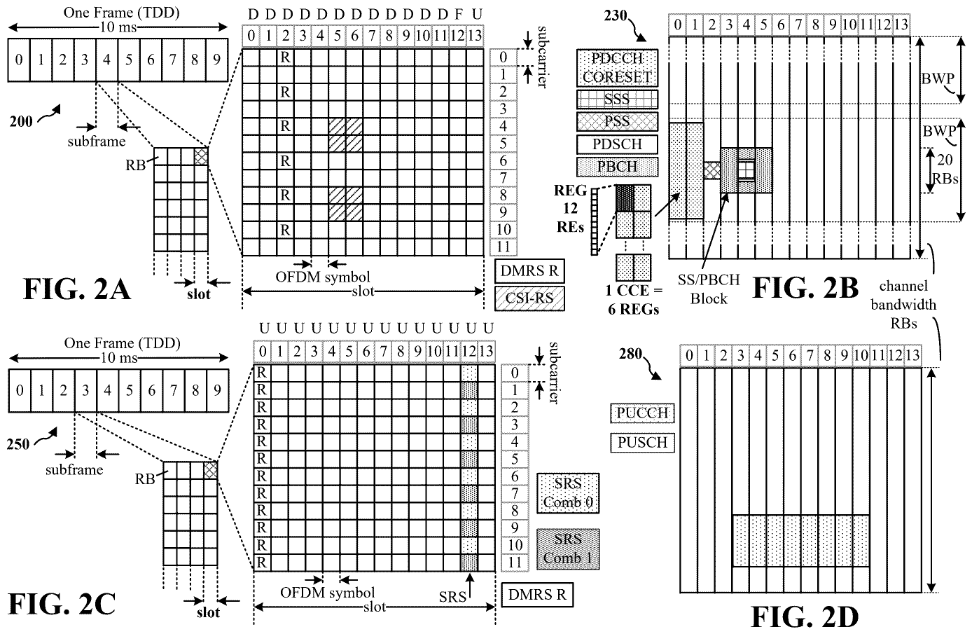

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

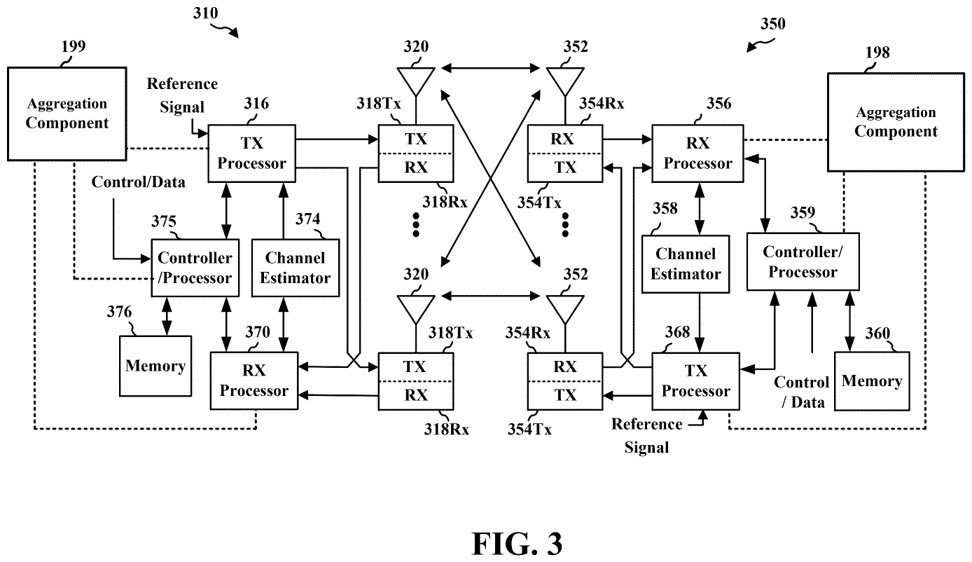

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

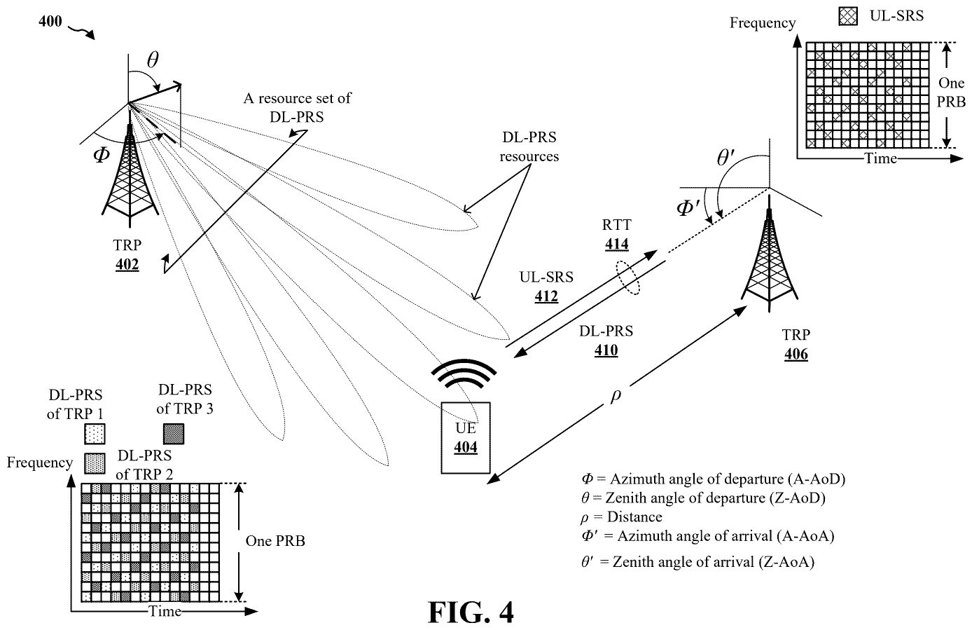

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time TSRS RX and transmit the DL-PRS 410 at time TPRS_TX. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Positioning measurements and operations may be utilized to locate wireless devices in wireless communication networks. For example, a wireless communication network may utilize pilot signals transmitted via reference signal resources such as SRS resources and/or PRS resources. Such reference signal resources may have characteristics such as TxTEG identifiers, transmission timing error margins, transmission timing errors, and/or the like. To improve efficiency in positioning measurements and operations, reference signal resources may be aggregated for transmissions. However, coherency for transmissions of aggregated reference signal resources may affect accuracy in positioning information and operations. A UE may not be aware of a loss of coherency for aggregated reference signal resources until after the transmission via aggregated reference signal resources has occurred. Thus, accuracy for timing and positioning at the network side may be impacted. Moreover, signaling overhead for reference signal resource characteristics (e.g., TxTEG identifiers, transmission timing error margins, transmission timing errors, etc.) may include additional processing (e.g., encoding/decoding) and power consumption for transmitters and receivers.

Aspects herein for aggregation of SRS and PRS resources in positioning transmissions may provide enhancements to accuracy, signaling overhead, and processing power, as well as improving bandwidth and supporting cross-CC pathloss reference indications for intra-band aggregation, for positioning measurements/operations by reporting indications of coherency status information for aggregated reference signal resources and associating TxTEG identifiers and timing error margins to unassigned or untagged reference signal resources.

While various aspects may be described in the context of aggregation for SRS and/or PRS resources in the context of positioning measurements for descriptive and illustrative purposes, aspects are not so limited and may be applicable to other types of resources and operations, as would be understood by persons of skill in the relevant art(s) having the benefit of this disclosure.

Aspects may relate to bandwidth aggregation for positioning measurements across up to three intra-band contiguous carriers, as well as signaling and procedures to support aggregation of PRS/SRS (respectively) resources across PFLs/carriers (respectively) for positioning measurements (e.g., where the signals over aggregated resources are transmitted and received (respectively) using a single RF chain (e.g., via a same antenna)); bandwidth aggregation for positioning measurements may be applicable to timing related measurements (e.g., RSTD, RTOA, and UE/gNB Rx-Tx time differences). Aspects may also relate to radio resource management (RRM) characteristics for measurement gaps in a RRC connected mode, and in inactive mode, including PRS measurement period/reporting. PRS aggregation across PFLs and signaling aspects may relate to assistance data enhancements for enabling PRS aggregation, including, but without limitation, handling of tones/subcarriers gap in between the CCs, PRS aggregation within a measurement gap (MG), PRS aggregation within a PRS processing window (PPW), etc. Aspects may also relate to performance characteristics for the aggregated bandwidth of resources (e.g., 200 MHz from two aggregated 100 MHz reference signal resources). Aspects may also relate to SRS aggregation and signaling, including, but without limitation, concurrent SRS transmissions on intra-band contiguous carrier aggregation (CA), signaling of which SRS should be transmitted coherently, etc.

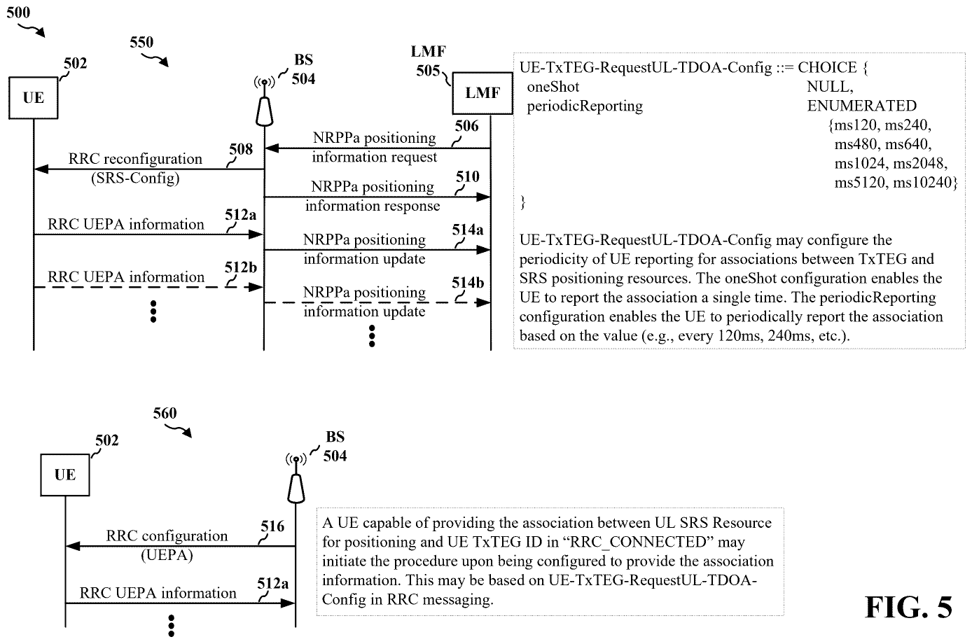

FIG. 5 shows a diagram 500 of examples of call flow diagrams and configurations for wireless communications, in various aspects. Diagram 500 includes a call flow diagram 550 for a UE 502, a base station 504, and a LMF 505, as well as a call flow diagram 560 for the UE 502 and the base station 504.

In call flow diagram 550, the LMF 505 may be configured to provide a NR positioning protocol A (NRPPa) positioning information request 506 to the base station 504. The NRPPa positioning information request 506 may include a request for TxTEG reporting. TxTEG reporting may include reporting criteria in RRC signaling as an RRC reconfiguration 508 which may be an SRS configuration (e.g., “SRS-Config”), as shown in diagram 500 for a UE TxTEG request UL TDOA configuration (“UE-TxTEG-RequestUL-TDOA-Config”). Such a configuration may configure the periodicity of UE reporting for associations between TxTEG and SRS positioning resources. A one shot (oneShot) configuration may enable the UE to report the association a single time, and a periodic reporting (periodicReporting) configuration may enable the UE to periodically report the association based on the value (e.g., every 120 ms, 240 ms, etc.). The RRC reconfiguration 508 may be provided by the base station 504 to the UE 502, and the base station 504 may be configured to provide a NRPPa positioning information response 510 back to the LMF 505.

The UE 502 may be configured to provide RRC UE positioning assistance (UEPA) information 512a to the base station 504. The RRC UEPA information 512a may be a RRC UL dedicated control channel (DCCH) message for UEPA information (“UEPositioningAssistanceInfo”) to report associations between UL SRS resources for positioning, as well as a UE TxTEG identifier. The base station 504 may then be configured to provide a NRPPa positioning information update 514a to the LMF 505 based on the RRC UEPA information 512a. The UE 502 may be configured to provide later or updated RRC UEPA information, e.g., a RRC UEPA information 512b, based on which the base station 504 may be configured to provide a NRPPa positioning information update 514b to the LMF 505. Such subsequent updating may similarly continue, e.g., with another RRC UEPA information (not shown) provided to the base station 504 from the UE 502, and correspondingly, another NRPPa positioning information update (not shown) provided by the base station 504 to the LMF 505.

The UEPA information procedure may be used by the UE 502 to report the UEPA information (e.g., 512a). The UE 502 may report the association between UL-SRS resources for positioning and the UE Tx TEG identifier. In call flow diagram 560, the base station 504 may be configured to provide, and the UE 502 may be configured to receive, a RRC configuration 516 for configuring the UE for UEPA, as referenced above. For instance, when the UE 502 is capable of providing the association between UL SRS resources for positioning, a UE TxTEG identifier(s) in “RRC_CONNECTED” may initiate the procedure upon being configured to provide the association information. This may be based on RRC reconfiguration 508, e.g., in call flow diagram 550, which may be an SRS configuration for a UE TxTEG request UL TDOA configuration (“ue-TxTEG-RequestUL-TDOA-Config”).

Upon initiation of the procedure, the UE 502 may be configured to perform the following operations. The UE 502 may be configured to initiate transmission of the UEPositioningAssistanceInfo message to provide the association escribed above, which may include further actions related to transmission of the UEPositioningAssistanceInfo message. For example, the UE 502 may be configured to set the contents of the UEPositioningAssistanceInfo message as follows. If a ue-TxTEG-RequestUL-TDOA-Config in a RRCReconfiguration message is configured with periodicReporting, for all the association changes, the UE 502 may store a ue-TxTEG-Association corresponding to each ue-TxTEG-ID with a nr-TimeStamp. The UE 502 may also be configured to include the results in a ue-TxTEG-AssociationList in the UEPositioningAssistanceInfo message on expiry of each configured period. the UE 502 may be configured to include a ue-TxTEG-TimingErrorMargin Value for each UEPositioningAssistanceInfo message. If the ue-TxTEG-RequestUL-TDOA-Config in the RRCReconfiguration message is not configured with periodicReporting, but is configured with oneShot, the UE 502 may also be configured to identify the ue-TxTEG-Association corresponding to each ue-TxTEG-ID with nr-TimeStamp, and to include the results in the ue-TxTEG-AssociationList in the UEPositioningAssistanceInfo message a single time. The UE 502 may also be configured to include a ue-TxTEG-TimingErrorMargin Value 1 for each UEPositioningAssistanceInfo message. The UE 502 may be configured to submit the UEPositioningAssistanceInfo message to lower layers for transmission.

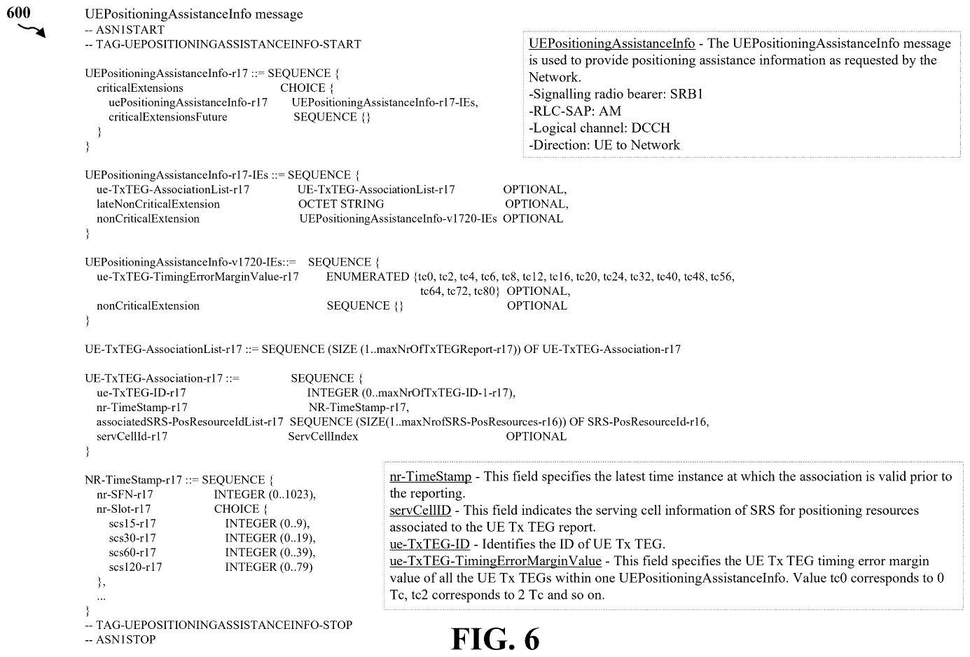

FIG. 6 shows a diagram 600 of examples of configurations for wireless communications, in various aspects. For instance, diagram 600 illustrates a configuration for a UEPA information (“UEPositioningAssistanceInfo”) message. In aspects, the configuration for the UEPA information message in diagram 600 may be utilized in conjunction with the aspects described above for FIG. 5.

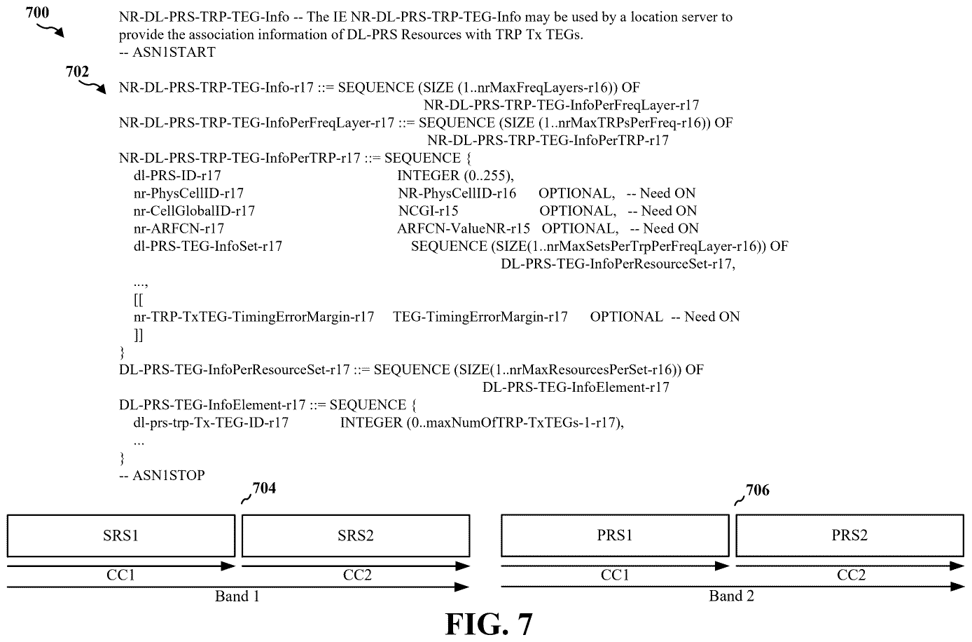

FIG. 7 shows a diagram 700 of example block diagrams and configurations for wireless communications, in various aspects. For instance, diagram 700 illustrates a configuration 702, an SRS aggregation 704 for intra-band contiguous aggregation, and a PRS aggregation 706 for intra-band contiguous aggregation.

The configuration 702 is illustrates an information element (IE) for NR DL PRS TRP timing error group (TEG) information (“NR-DL-PRS-TRP-TEG-Info”). The IE for NR-DL-PRS-TRP-TEG-Info may be used by a location server (e.g., a LMF) to provide the association information of DL-PRS Resources with TRP TxTEGs.

The SRS aggregation 704 for intra-band contiguous aggregation shows an SRS resource SRS1 and an SRS resource SRS2 that are aggregated in a band (“band 1”). SRS1 and SRS2 are aggregated across CCs, e.g., a first CC (CC1) and a second CC (CC2) of band 1. Additionally, a same cross-CC pathloss-reference parameter may be associated with SRS1 and SRS2. SRS aggregation 704 enables an effective bandwidth that is double that of SRS1 and SRS2 when not aggregated. For instance, if SRS1 and SRS2 are each at 100 MHz, when SRS1 and SRS2 are aggregated in band 1, the bandwidth is doubled to 200 MHz.

The PRS aggregation 706 for intra-band contiguous aggregation shows a PRS resource PRS1 and a PRS resource PRS2 that are aggregated in a band (“band 2”). PRS1 and SRS2 are aggregated across CCs, e.g., a first CC (CC1) and a second CC (CC2) of band 2. Additionally, a same cross-CC pathloss-reference parameter may be associated with PRS1 and PRS2. PRS aggregation 706 enables an effective bandwidth that is double that of PRS1 and PRS2 when not aggregated. For instance, if PRS1 and PRS2 are each at 100 MHz, when PRS1 and PRS2 are aggregated in band 1, the bandwidth is doubled to 200 MHz.

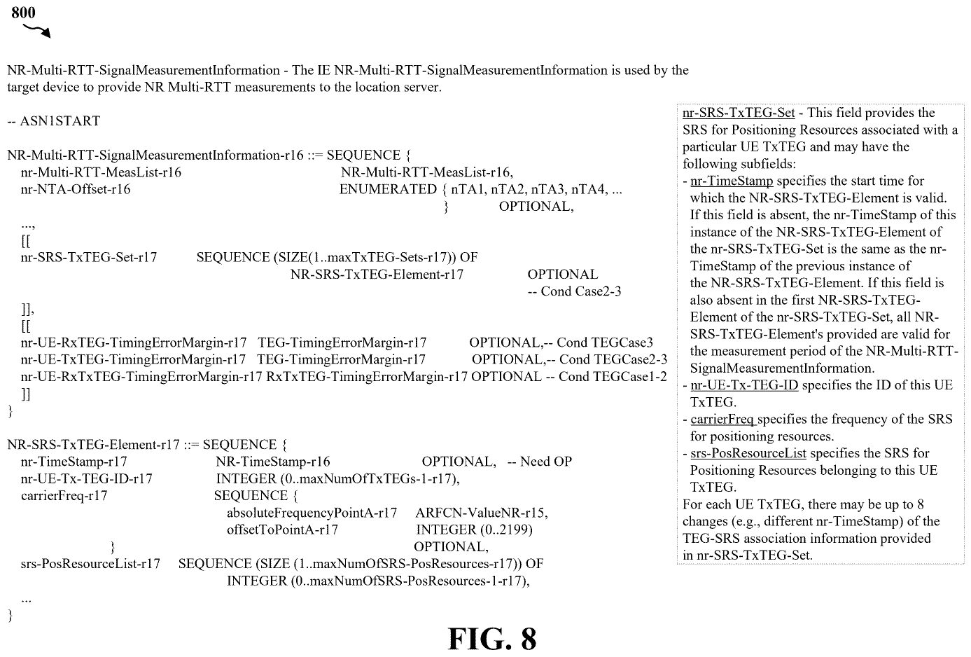

FIG. 8 shows a diagram 800 of example configurations for wireless communications, in various aspects. For instance, diagram 800 illustrates a configuration for TxTEG reporting in long term evolution (LTE) positioning protocol (LPP). In aspects, the configuration for TxTEG reporting in diagram 800 may be associated with an IE for NR Multi-RTT signal measurement information (NR-Multi-RTT-SignalMeasurementInformation). This IE and information may be transmitted via LPP and may be utilized used by a target device, e.g., a UE, to provide NR multi-RTT measurements to a location server, e.g., an LMF.

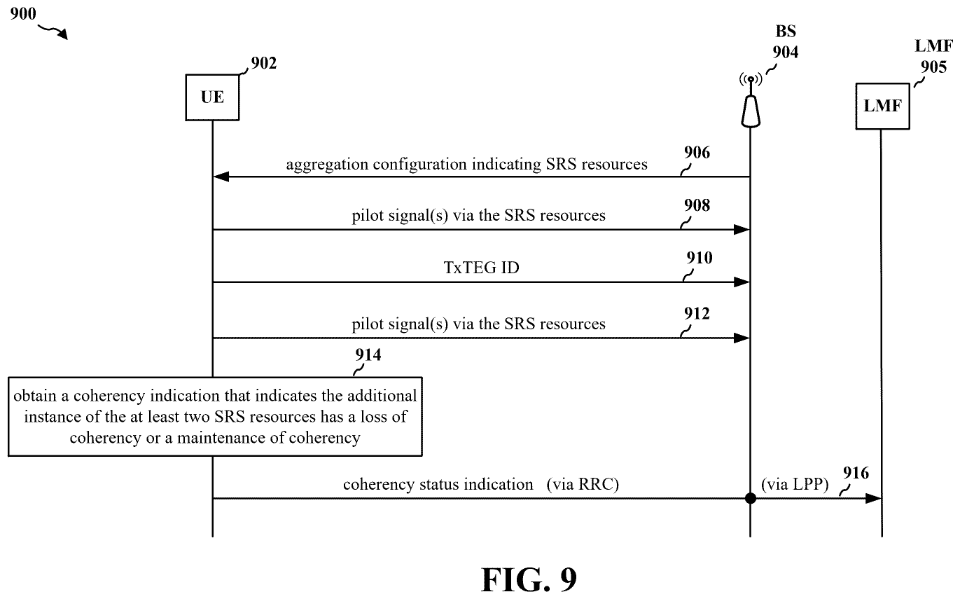

FIG. 9 is a call flow diagram 900 for wireless communications, in various aspects. Call flow diagram 900 illustrates SRS aggregation in positioning transmissions for a UE (e.g., a UE 902) that may communicate with a network node (a base station 904, such as a gNB or other type of base station, by way of example, as shown), each of which may communication with a network entity (e.g., an LMF 905). Aspects described for the base station 904 may be performed by the base station in aggregated form and/or by one or more components of the base station 904 in disaggregated form. Additionally, or alternatively, the aspects may be performed by the UE 902 autonomously, in addition to, and/or in lieu of, operations of the base station 904.

In the illustrated aspect, the UE 902 may be configured to receive, as provided from the base station 904, an aggregation configuration 906 that indicates SRS resources. The SRS resources may be at least two SRS resources to be aggregated in an UL transmission. In aspects, the aggregation configuration 906 may be provided by the base station 904 for the UE 902 via RRC signaling and/or the like. The UE 902 may be configured to transmit or provide for the base station 904 a pilot signal 908 via the SRS resources, based on the aggregation configuration 906. The pilot signal 908 may be at least one pilot signal, in aspects, and the SRS resources may be aggregated with a coherency property in a same set of OFDM symbols. The SRS resources may be associated with a same pathloss parameter, a same transmit power spectral density, a same spatial relation reference signal, a same comb size, and/or at least one same time-domain characteristic (e.g., periodicity), and may also have a same slot and/or a same numerology. In aspects, the same pathloss parameter may be associated with a cross-CC pathloss reference indication, and the UE 902 may be configured to transmit or provide to the base station 904 the at least two SRS resources with the cross-CC pathloss reference indication.

The UE 902 may be configured to transmit or provide for the base station 904 a TxTEG identifier (ID) 910. The TxTEG identifier 910 may be assigned to a first SRS resource of the at least two SRS resources, and a second SRS resource of the at least two SRS resources may be associated with the TxTEG identifier 910 in an absence of an assignment of the TxTEG identifier 910 to the second SRS resource. In one aspect, the UE 902 may be configured to transmit the TxTEG identifier 910 with, or in association with, at least one transmission timing error margin that is assigned to the first SRS resource of the at least two SRS resources. In such aspects, the second SRS resource of the at least two SRS resources is associated with the at least one transmission timing error margin in an absence of an assignment of the at least one transmission timing error margin to the second SRS resource (e.g., where the at least two SRS resources may have a transmission timing mismatch therebetween).

In one aspect, the UE 902 may be configured to transmit the TxTEG identifier 910 with, or in association with, a transmission timing error margin assigned to the first SRS resource and the second SRS resource of the at least two SRS resources. The first SRS resource may be aggregated with the second SRS resource, and the first SRS resource and the second SRS resource may have a same transmission timing error. In such an aspect, the UE 902 may be configured to transmit, based on the aggregation configuration 906, at least one additional pilot signal 912 via at least one additional SRS resource. The at least one additional SRS resource may be assigned an additional TxTEG identifier that is different from the TxTEG identifier 910, and the at least one additional SRS resource may be assigned an additional transmission timing error margin that is greater than the transmission timing error margin for the TxTEG identifier 910. In such aspects, the UE 902 may be configured to transmit, based on the aggregation configuration 906, the at least one additional pilot signal 912 via at least one additional SRS resource. The at least one additional SRS resource may be assigned an additional TxTEG identifier that is different from the TxTEG identifier 910, and the at least one additional SRS resource may be assigned an additional transmission timing error margin that is greater than the transmission timing error margin for the TxTEG identifier 910.

The UE 902 may, at some time, transmit pilot signals via the SRS resources, as similarly noted above, but with a loss of coherency for the SRS resources. A loss of coherency may be due to another channel scheduled for frequency division multiplexing (FDM), due to per-CC group-delay variations, or due to other reasons. The UE 902 may not determine that a loss of coherency has taken place, or that coherency has been maintained, until after transmission of a pilot signal(s) via the SRS resources has occurred. Accordingly, The UE 902 may be configured to obtain (914) a coherency indication that indicates the additional instance of the at least two SRS resources has a loss of coherency or a maintenance of coherency. Based on obtaining (914) the coherency indication, the UE 902 may be configured to transmit or provide, and the base station 904 and/or the LMF 905 may be respectively configured to receive, a coherency status indication 916. That is, the UE 902 may be configured to transmit the coherency status indication 916 to include information associated with the loss of coherency or the maintenance of coherency for the additional instance of the at least two SRS resources via which the at least one additional pilot signal 912 was transmitted.

The UE 902 may be configured to transmit/provide the coherency status indication 916 to the base station 904 in association with an uplink time difference of arrival (U-TDOA) via RRC signaling. In such an aspect, the coherency status indication may be in an information element (IE) for UEPA information. The UE 902 may also be configured to transmit/provide the coherency status indication 916 to the LMF 905. In such an aspect, the UE 902 may be associated with multi-round trip time (M-RTT) positioning, and may be configured to transmit the coherency status indication 916 for the LMF (as a network entity) via LPP signaling in NR M-RTT signal measurement information.

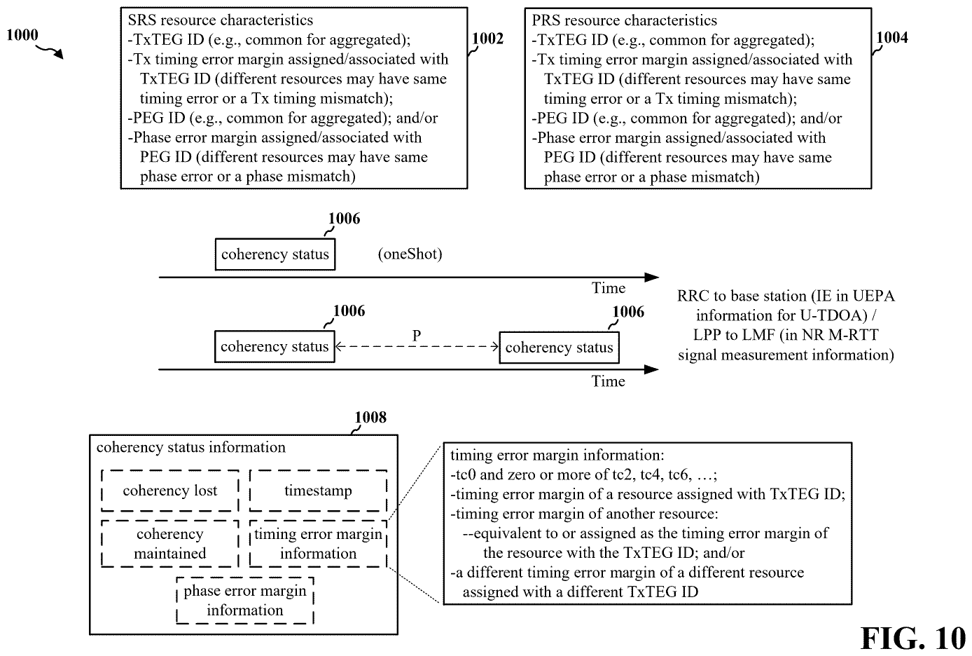

FIG. 10 shows a diagram 1000 of example configurations for coherency status and transmission timing error margin for SRS/PRS resources, in various aspects. Aspects of diagram 1000 may be described further in the context of the description above for call flow diagram 900.

Diagram 1000 includes characteristics of an SRS resource 1002, which may represent one or more SRS resource instances. The characteristics of the SRS resource 1002 may include, without limitation, a TxTEG ID (e.g., which may be common for aggregated SRS resources, a Tx timing error margin assigned or associated with the TxTEG ID (e.g., different resources may have the same timing error or may have a Tx timing mismatch), a phase error group (PEG) identifier (e.g., which may be common for aggregated SRS resources), a phase error margin assigned or associated with the PEG identifier (e.g., where different resources may have the same phase error or may have a phase mismatch (e.g., in degrees, etc.)). In aspects, the phase error margin may be a soft metric reported for coherency status information and may be a maximum phase difference between two SRS resources.

Diagram 1000 also includes characteristics of a PRS resource 1004, which may represent one or more PRS resource instances. The characteristics of the PRS resource 1004 may include, without limitation, a TxTEG ID (e.g., which may be common for aggregated SRS resources, a Tx timing error margin assigned or associated with the TxTEG ID (e.g., different resources may have the same timing error or may have a Tx timing mismatch), a phase error group (PEG) identifier (e.g., which may be common for aggregated SRS resources), a phase error margin assigned or associated with the PEG identifier (e.g., where different resources may have the same phase error or may have a phase mismatch (e.g., in degrees, etc.)). In aspects, a first SRS resource and a second SRS resource that are aggregated may be assigned a PEG identifier that is different from an additional PEG identifier assigned to at least one additional SRS resource.

Diagram 1000 also includes an illustration of reporting a coherency status indication 1008 for coherency status information. For example, a UEPositioningAssistanceInfo IE 1006 for UEPA information may be utilized to provide the coherency status indication 1008 of coherency status information. As noted above, a coherency status indication may be transmitted or provided as at least one of a standalone transmission or periodic transmissions—that is, in some aspects, periodic reporting may be combined with single, aperiodic reporting instances. Coherency status information may be provided as an indication in a single report (e.g., per a “oneShot” configuration) or in periodically repeating reports (e.g., per a “periodicReporting” configuration”). As also described with respect to FIG. 9, a UE may to transmit or provide a coherency status indication to a base station in association with a U-TDOA via RRC signaling in an IE for UEPA information. The UE may also be configured to transmit or provide a coherency status indication to an LMF when the UE is associated with M-RTT positioning, and the coherency status indication may be transmitted via LPP signaling in NR M-RTT signal measurement information.

Diagram 1000 also includes an illustration of example of the coherency status indication 1008 for coherency status information. The coherency status indication 1008 may include coherency status information such as an indication of coherency being lost, an indication of coherency being maintained, a transmission timestamp, Tx timing error margin information, phase error margin information, and/or the like, without limitation. A transmission timestamp associated with the loss of coherency or the maintenance of coherency for the at least two SRS resources may be included with the coherency status indication 1008. A phase error margin assigned or associated with the PEG identifier (e.g., where different resources may have the same phase error or may have a phase mismatch (e.g., in degrees, etc.)), as described above, may also be included in the coherency status indication 1008. In aspects, the phase error margin may be a soft metric reported for coherency status information and may be a maximum phase difference between two SRS resources.

The coherency status indication 1008 may also include information associated with at least one transmission timing error margin between at least two SRS resources. In aspects, a timing error margin of a first resource assigned with TxTEG ID may be associated with a second resource that is aggregated with the first resource. In aspects, a first transmission timing error margin between at least two SRS resources may be equivalent to a second transmission timing error margin associated with a TxTEG identifier assigned to a first SRS resource of the at least two SRS resources. A timing error margin of another aggregated resource may be included in the coherency status indication 1008, and may be equivalent to or assigned as the timing error margin of the resource with the TxTEG ID. A different timing error margin of a different, unaggregated resource may be assigned with a different TxTEG ID may be included in the coherency status indication 1008. In aspects, first transmission timing error margin may be a subset of the second transmission timing error margin. In some aspects, the first transmission timing error margin may include a tc0 enumeration, and in further aspects, one or more enumerations for tc2, tc4, tc6, tc8, tc12, tc16, tc20, tc24, tc32, tc40, tc48, tc56, tc64, tc72, tc80, etc., may also be included.

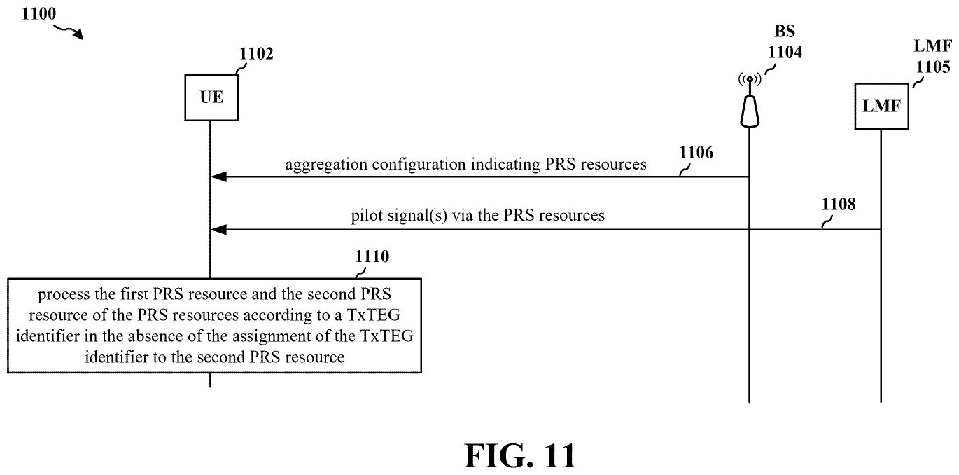

FIG. 11 is a call flow diagram 1100 for wireless communications, in various aspects. Call flow diagram 1100 illustrates PRS aggregation in positioning transmissions for a UE (e.g., a UE 1102) that may communicate with a network node (a base station 1104, such as a gNB or other type of base station, by way of example, as shown), each of which may communication with a network entity (e.g., an LMF 1105). Aspects described for the base station 1104 may be performed by the base station in aggregated form and/or by one or more components of the base station 1104 in disaggregated form. Additionally, or alternatively, the aspects may be performed by the UE 1102 autonomously, in addition to, and/or in lieu of, operations of the base station 1104.

In the illustrated aspect, the UE 1102 may be configured to receive, from the base station 1104 (e.g., a network node), an aggregation configuration 1106 that indicates PRS resources. In aspects, the aggregation configuration 1106 may indicate at least two PRS resources to be aggregated in a DL transmission. The UE 1102 may also be configured to receive, from the LMF 1105 (e.g., a network entity) based on the aggregation configuration 1106, at least one pilot signal 1108 via the at least two PRS resources. In aspects, the at least two PRS resources may be aggregated with a coherency property. A second PRS resource of the at least two PRS resources may be associated with a TxTEG identifier, in an absence of an assignment of the TxTEG identifier to the second PRS resource, based on assistance information that indicates a first PRS resource of the at least two PRS resources is assigned to the TxTEG identifier.

In one aspect, the UE 1102 may be configured to receive at least one additional pilot signal via at least one additional PRS resource, where the at least one additional PRS resource is assigned an additional TxTEG identifier that is different from the TxTEG identifier of the aggregated at least two PRS resources. In such aspects, the at least one additional PRS resource is assigned an additional timing error margin that is greater than the timing error margin associated with the TxTEG identifier of the aggregated at least two PRS resources.

The UE 1102 may be configured to process (at 1110) the first PRS resource and the second PRS resource of the at least two PRS resources according to the TxTEG identifier in the absence of the assignment of the TxTEG identifier to the second PRS resource. In aspects, the first PRS resource of the at least two PRS resources may be assigned a timing error margin based on the assistance information, and the second PRS resource of the at least two PRS resources may be associated with the timing error margin in an absence of an assignment of the timing error margin to the second PRS resource. In such aspects, the at least two PRS resources may have a transmission timing mismatch therebetween. In aspects, the first PRS resource and the second PRS resource of the at least two PRS resources may be assigned a timing error margin. In such aspects, the first PRS resource may be aggregated with the second PRS resource, and the first PRS resource and the second PRS resource may have a same transmission timing error.

In some aspects, the aggregation configuration 1106 may further indicate at least one resolution granularity parameter or field that may be associated with a timing error margin for the at least two PRS resources. In some such aspects, the resolution granularity parameter or field may be a timing reporting granularity factor (“timingReportingGranularityFactor”) that may specify a recommended reporting granularity for UE Rx-Tx time difference measurements. In some aspects, a ‘Value’ in a range (0 . . . 5) may correspond to (k0 . . . k5) an may be used for a NR UE Rx-Tx time difference (“nr-UE-RxTxTimeDiff”) and/or a NR UE Rx-Tx time difference addition (“nr-UE-RxTxTimeDiffAdditional”) in a NR multi-RTT measurement element (“NR-Multi-RTT-MeasElement’). The UE may select a different granularity value for nr-UE-RxTxTimeDiff and/or nr-UE-RxTxTimeDiffAdditional, in aspects. With respect to report mappings, a reporting range of a base station (e.g., a gNB) Rx-Tx time difference may be defined from −985024*Tc to +985024*Tc. The reporting resolution may be uniform across the reporting range and may be defined as T=Tc*2^{k} (or Tc*2\hat{ }k), where ‘k’ may be selected by the base station from the set {0, 1, 2, 3, 4, 5}. In aspects, the timing constant may be defined as Tc=1/(delta−fmax*Nf) where delta−fmax=480,000 Hz and Nf=4096. In aspects, an LMF may be configured to provide a recommended resolution parameter, timingReportingGranularityFactor, and a base station may be configured to select the parameter ‘k’ based on timingReportingGranularityFactor, after which the base station may inform the LMF of the selection.

In some aspects, the at least one resolution granularity parameter may be extended to include at least one negative integer power for ‘k’ (e.g., −1, −2, . . . , etc.) that may be associated with a time of the timing error margin that is Tc*2^{k} in the DL transmission. That is, ‘k’ may be a negative integer, according to the aspects herein. In some aspects, the at least one resolution granularity parameter may be an integer power ‘k’ of 1 (one) or 2 (two) and may be associated with a time of the timing error margin that is Tc*2^{k} in a FR1 DL transmission. Thus, aspects herein provide configurations for improved granularity for timing reporting, e.g., for receive-transmit time differences, whereby the described techniques can be used to improve precision in timing measurements and/or reporting

The UE 1102 may be further configured to transmit measurement information associated with at least one of reference signal time difference measurements or UE reception-transmission (RxTx) time difference measurements that may be aggregated via at least two positioning frequency layers (PFLs). In such aspects, the at least one of reference signal time difference measurements or UE RxTx time difference measurements may be associated with the at least two PRS resources, as described above, and corresponding additional path information may be aggregated via the at least two PFLs. In some aspects, the corresponding additional path information may include at least one of a line of sight (LOS) flag or a non-line of sight (NLOS) flag. The LOS flag and/or the NLOS flag may be assigned to a first PFL of the at least two PFLs or may be associated with a second PFL of the at least two PFLs in an absence of an assignment of the LOS flag and/or the NLOS flag to the second PFL. Accordingly, by extending associations of characteristics for aggregated resources to aggregations in PFLs, aspects herein may be used to improve RSTD and UE RxTx time difference measurements, as well as to reduce signaling overhead.

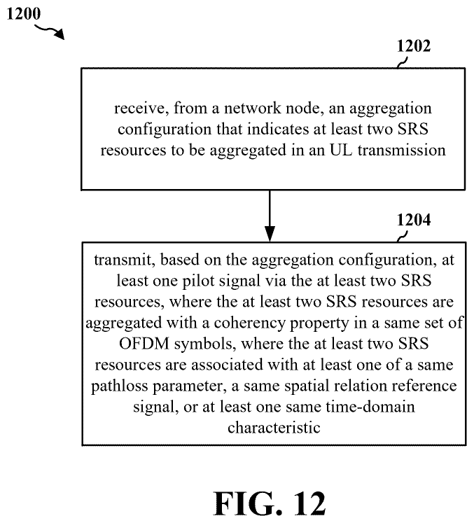

FIG. 12 is a flowchart 1200 of a method of wireless communication, in various aspects. The method may be performed by a UE (e.g., the UE 104, 404, 502, 902, 1102; the apparatus 1604). In some aspects, the method may include aspects described in connection with the communication flow in FIG. 9 and/or aspects described in FIGS. 4-8 and 10. The method provides for SRS aggregation in positioning transmissions that enables a UE to inform a network node (e.g., a base station) and/or a network entity (e.g., an LMF) of coherency status information and to associate characteristics of an SRS resource with other SRS resources aggregated therewith, including intra-band aggregation across CCs, to reduce signaling overhead and RxTx processing (e.g., encoding/decoding).

At 1202, the UE receives, from a network node, an aggregation configuration that indicates at least two SRS resources to be aggregated in an UL transmission. As an example, the reception may be performed by the component 198. FIGS. 7, 9, 10 illustrates an example of the UE 902 performing such a reception for an aggregation configuration, from a network node (e.g., the base station 904).

The UE 902 may be configured to receive, as provided from the base station 904, an aggregation configuration 906 that indicates SRS resources (e.g., SRS aggregation 704 in FIG. 7; SRS resource 1002 in FIG. 10). The SRS resources (e.g., SRS aggregation 704 in FIG. 7; SRS resource 1002 in FIG. 10) may be at least two SRS resources (e.g., SRS aggregation 704 in FIG. 7; SRS resource 1002 in FIG. 10) to be aggregated in an UL transmission. In aspects, the aggregation configuration 906 may be provided by the base station 904 for the UE 902 via RRC signaling and/or the like.

At 1204, the UE transmits, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, and/or at least one same time-domain characteristic (e.g., periodicity). As an example, the transmission may be performed by the component 198. FIGS. 7, 9, 10 illustrate an example of the UE 902 performing such a transmission for pilot signal(s) via SRS resources (e.g., the base station 904, a network node).

The UE 902 may be configured to transmit or provide, e.g., for the base station 904, a pilot signal 908 via the SRS resources, based on the aggregation configuration 906. The pilot signal 908 may be at least one pilot signal, in aspects, and the SRS resources (e.g., SRS aggregation 704 in FIG. 7; SRS resource 1002 in FIG. 10) may be aggregated with a coherency property in a same set of OFDM symbols. The SRS resources (e.g., SRS aggregation 704 in FIG. 7; SRS resource 1002 in FIG. 10) may be associated with a same pathloss parameter, a same transmit power spectral density, a same spatial relation reference signal, a same comb size, and/or at least one same time-domain characteristic (e.g., periodicity), and may also have a same slot and/or a same numerology. In aspects, the same pathloss parameter may be associated with a cross-CC pathloss reference indication (e.g., SRS1, SRS2 in FIG. 7), and the UE 902 may be configured to transmit or provide to the base station 904 the at least two SRS resources (e.g., SRS aggregation 704 in FIG. 7; SRS resource 1002 in FIG. 10) with the cross-CC pathloss reference indication.

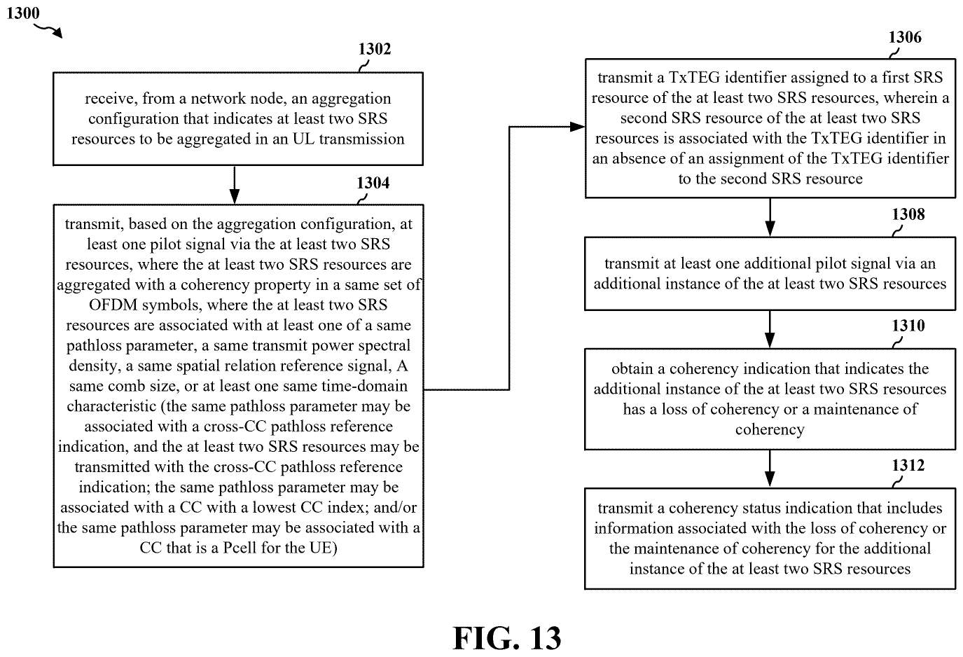

FIG. 13 is a flowchart 1300 of a method of wireless communication, in various aspects. The method may be performed by a UE (e.g., the UE 104, 404, 502, 902, 1102; the apparatus 1604). In some aspects, the method may include aspects described in connection with the communication flow in FIG. 9 and/or aspects described in FIGS. 4-8 and 10. The method provides for PRS/SRS aggregation in positioning transmissions that enables a UE to inform a network node (e.g., a base station) and/or a network entity (e.g., an LMF) of coherency status information and to associate characteristics of an SRS/PRS resource with other SRS/PRS resource aggregated therewith, including intra-band aggregation across CCs, to reduce signaling overhead and RxTx processing (e.g., encoding/decoding).

At 1302, the UE receives, from a network node, an aggregation configuration that indicates at least two SRS resources to be aggregated in an UL transmission. As an example, the reception may be performed by the component 198. FIG. 9 illustrates an example of the UE 902 performing such a reception for an aggregation configuration, from a network node (e.g., the base station 904).

The UE 902 may be configured to receive, as provided from the base station 904, an aggregation configuration 906 that indicates SRS resources. The SRS resources (e.g., SRS aggregation 704 in FIG. 7; SRS resource 1002 in FIG. 10) may be at least two SRS resources (e.g., SRS aggregation 704 in FIG. 7; SRS resource 1002 in FIG. 10) to be aggregated in an UL transmission. In aspects, the aggregation configuration 906 may be provided by the base station 904 for the UE 902 via RRC signaling and/or the like.

At 1304, the UE transmits, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, and/or at least one same time-domain characteristic (e.g., periodicity). As an example, the transmission may be performed by the component 198. FIG. 9 illustrates an example of the UE 902 performing such a transmission for a pilot signal(s) via SRS resources (e.g., to the base station 904, a network node).

The UE 902 may be configured to transmit or provide, e.g., for the base station 904, a pilot signal 908 via the SRS resources (e.g., SRS aggregation 704 in FIG. 7; SRS resource 1002 in FIG. 10), based on the aggregation configuration 906. The pilot signal 908 may be at least one pilot signal, in aspects, and the SRS resources (e.g., SRS aggregation 704 in FIG. 7; SRS resource 1002 in FIG. 10) may be aggregated with a coherency property in a same set of OFDM symbols. The SRS resources (e.g., SRS aggregation 704 in FIG. 7; SRS resource 1002 in FIG. 10) may be associated with a same pathloss parameter, a same transmit power spectral density, a same spatial relation reference signal, a same comb size, and/or at least one same time-domain characteristic (e.g., periodicity), and may also have a same slot and/or a same numerology. In aspects, the same pathloss parameter may be associated with a cross-CC pathloss reference indication (e.g., SRS1, SRS2 in FIG. 7), and the UE 902 may be configured to transmit or provide to the base station 904 the at least two SRS resources (e.g., SRS aggregation 704 in FIG. 7; SRS resource 1002 in FIG. 10) with the cross-CC pathloss reference indication (e.g., SRS1, SRS2 in FIG. 7). The same pathloss parameter may be associated with a CC with a lowest CC index, in aspects. The same pathloss parameter may be associated with a CC that is a Pcell for the UE, in aspects.

At 1306, the UE transmits a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. As an example, the transmission may be performed by the component 198. FIG. 9 illustrates an example of the UE 902 performing such a transmission for a TxTEG identifier (e.g., to the base station 904, a network node).

The UE 902 may be configured to transmit or provide for the base station 904 a TxTEG identifier (ID) 910 (e.g., TxTEG ID in SRS resource 1002 in FIG. 10). The TxTEG identifier 910 (e.g., TxTEG ID in SRS resource 1002 in FIG. 10) may be assigned to a first SRS resource (e.g., SRS resource 1002 in FIG. 10) of the at least two SRS resources (e.g., SRS aggregation 704 in FIG. 7; SRS resource 1002 in FIG. 10), and the second SRS resource (e.g., SRS resource 1002 in FIG. 10) of the at least two SRS resources (e.g., SRS aggregation 704 in FIG. 7; SRS resource 1002 in FIG. 10) may be associated with the TxTEG identifier 910 (e.g., TxTEG ID in SRS resource 1002 in FIG. 10) in an absence of an assignment of the TxTEG identifier 910 (e.g., TxTEG ID in SRS resource 1002 in FIG. 10) to the second SRS resource (e.g., SRS resource 1002 in FIG. 10). In one aspect, the UE 902 may be configured to transmit the TxTEG identifier 910 (e.g., TxTEG ID in SRS resource 1002 in FIG. 10) with, or in association with, at least one transmission timing error margin (e.g., Tx timing error margin in SRS resource 1002, in coherency status indication 1008 in FIG. 10) that is assigned to the first SRS resource (e.g., SRS resource 1002 in FIG. 10) of the at least two SRS resources (e.g., SRS aggregation 704 in FIG. 7; SRS resource 1002 in FIG. 10). In such aspects, the second SRS resource (e.g., SRS resource 1002 in FIG. 10) of the at least two SRS resources (e.g., SRS aggregation 704 in FIG. 7; SRS resource 1002 in FIG. 10) is associated with the at least one transmission timing error margin (e.g., Tx timing error margin in SRS resource 1002, in coherency status indication 1008 in FIG. 10) in an absence of an assignment of the at least one transmission timing error margin (e.g., Tx timing error margin in SRS resource 1002, in coherency status indication 1008 in FIG. 10) to the second SRS resource (e.g., SRS resource 1002 in FIG. 10) (e.g., where the at least two SRS resources may have a transmission timing mismatch therebetween). The UE 902 may be configured to transmit the TxTEG identifier 910 (e.g., TxTEG ID in SRS resource 1002 in FIG. 10) with, or in association with, a transmission timing error margin (e.g., Tx timing error margin in SRS resource 1002, in coherency status indication 1008 in FIG. 10) assigned to the first SRS resource and the second SRS resource of the at least two SRS resources (e.g., SRS aggregation 704 in FIG. 7; SRS resource 1002 in FIG. 10). The first SRS resource may be aggregated with the second SRS resource (e.g., SRS aggregation 704 in FIG. 7; SRS resource 1002 in FIG. 10), and the first SRS resource and the second SRS resource (e.g., SRS aggregation 704 in FIG. 7; SRS resource 1002 in FIG. 10) may have a same transmission timing error (e.g., Tx timing error margin in SRS resource 1002, in coherency status indication 1008 in FIG. 10).

At 1308, the UE transmits at least one additional pilot signal via an additional instance of the at least two SRS resources. As an example, the transmission may be performed by the component 198. FIG. 9 illustrates an example of the UE 902 performing such a transmission for a pilot signal(s) (e.g., to the base station 904, a network node).

The UE 902 may be configured to transmit, based on the aggregation configuration 906, at least one additional pilot signal 912 via at least one additional SRS resource (e.g., SRS resource 1002 in FIG. 10). The at least one additional SRS resource (e.g., SRS resource 1002 in FIG. 10) may be assigned an additional TxTEG identifier that is different from the TxTEG identifier 910 (e.g., TxTEG ID in SRS resource 1002 in FIG. 10), and the at least one additional SRS resource (e.g., SRS resource 1002 in FIG. 10) may be assigned an additional transmission timing error margin (e.g., Tx timing error margin in SRS resource 1002, in coherency status indication 1008 in FIG. 10) that is greater than the transmission timing error margin (e.g., Tx timing error margin in SRS resource 1002, in coherency status indication 1008 in FIG. 10) for the TxTEG identifier 910 (e.g., TxTEG ID in SRS resource 1002 in FIG. 10). In such aspects, the UE 902 may be configured to transmit, based on the aggregation configuration 906, the at least one additional pilot signal 912 via at least one additional SRS resource (e.g., SRS resource 1002 in FIG. 10). The at least one additional SRS resource (e.g., SRS resource 1002 in FIG. 10) may be assigned an additional TxTEG identifier that is different from the TxTEG identifier 910 (e.g., TxTEG ID in SRS resource 1002 in FIG. 10), and the at least one additional SRS resource (e.g., SRS resource 1002 in FIG. 10) may be assigned an additional transmission timing error margin (e.g., Tx timing error margin in SRS resource 1002, in the coherency status indication 1008 in FIG. 10) that is greater than the transmission timing error margin (e.g., Tx timing error margin in SRS resource 1002, in coherency status indication 1008 in FIG. 10) for the TxTEG identifier 910 (e.g., TxTEG ID in SRS resource 1002 in FIG. 10).

At 1310, the UE obtains a coherency indication that indicates the additional instance of the at least two SRS resources has a loss of coherency or a maintenance of coherency. As an example, the transmission may be performed by the component 198. FIG. 9 illustrates an example of the UE 902 obtaining a coherency indication.

The UE 902 may, at some time, transmit pilot signals (e.g., 912 or later instances thereof in FIG. 9) via the SRS resources (e.g., SRS resource 1002 in FIG. 10), as similarly noted above, but with a loss of coherency for the SRS resources (e.g., SRS resource 1002 in FIG. 10). A loss of coherency may be due to another channel scheduled for frequency division multiplexing (FDM), due to per-CC group-delay variations, or due to other reasons. The UE 902 may not determine that a loss of coherency has taken place, or that coherency has been maintained, until after transmission of a pilot signal(s) (e.g., 912 or later instances thereof in FIG. 9) via the SRS resources (e.g., SRS resource 1002 in FIG. 10) has occurred. Accordingly, The UE 902 may be configured to obtain (914) a coherency indication that indicates the additional instance of the at least two SRS resources (e.g., SRS resource 1002 in FIG. 10) has a loss of coherency or a maintenance of coherency. Based on obtaining (914) the coherency indication, the UE 902 may be configured to transmit or provide, and the base station 904 and/or the LMF 905 may be respectively configured to receive, a coherency status indication 916 (e.g., 1008 in FIG. 10). That is, the UE 902 may be configured to transmit the coherency status indication 916 (e.g., 1008 in FIG. 10) to include information associated with the loss of coherency or the maintenance of coherency for the additional instance of the at least two SRS resources (e.g., SRS resource 1002 in FIG. 10) via which the at least one additional pilot signal 912 was transmitted.

At 1312, the UE transmits a coherency status indication that includes information associated with the loss of coherency or the maintenance of coherency for the additional instance of the at least two SRS resources. As an example, the transmission may be performed by the component 198. FIG. 9 illustrates an example of the UE 902 performing such a transmission for a coherency status indication (e.g., to the base station 904, a network node; to the LMF 905, a network entity).

The UE 902 may be configured to transmit/provide the coherency status indication 916 (e.g., 1008 in FIG. 10) to the base station 904 in association with an uplink time difference of arrival (U-TDOA) via RRC signaling (e.g., 1006 in FIG. 10). In such an aspect, the coherency status indication 916 (e.g., 1008 in FIG. 10) may be in an information element (IE) for UEPA information (e.g., 1006 in FIG. 10). The UE 902 may also be configured to transmit/provide the coherency status indication 916 (e.g., 1008 in FIG. 10) to the LMF 905 (e.g., 1006 in FIG. 10). In such an aspect, the UE 902 may be associated with multi-round trip time (M-RTT) positioning (e.g., 1006 in FIG. 10), and may be configured to transmit the coherency status indication 916 (e.g., 1008 in FIG. 10) for the LMF 905 (as a network entity) via LPP signaling in NR M-RTT signal measurement information (e.g., 1006 in FIG. 10).

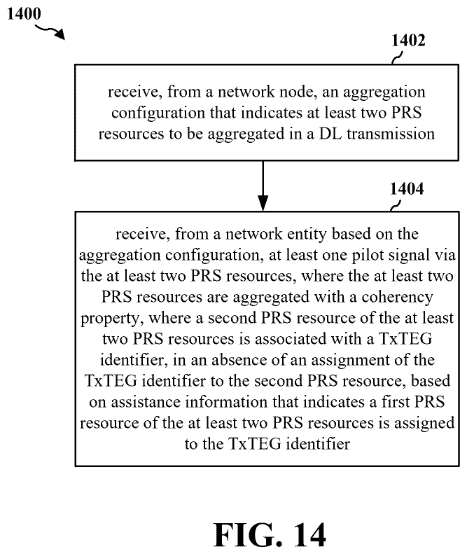

FIG. 14 is a flowchart 1400 of a method of wireless communication, in various aspects. The method may be performed by a UE (e.g., the UE 104, 404, 502, 902, 1102; the apparatus 1604). In some aspects, the method may include aspects described in connection with the communication flow in FIG. 11 and/or aspects described in FIGS. 4-8 and 10. The method provides for PRS aggregation in positioning transmissions that enables a UE to inform a network node (e.g., a base station) and/or a network entity (e.g., an LMF) of coherency status information and to associate characteristics of a PRS resource with other PRS resources aggregated therewith, including intra-band aggregation across CCs, to reduce signaling overhead and RxTx processing (e.g., encoding/decoding).

At 1402, the UE receives, from a network node, an aggregation configuration that indicates at least two PRS resources to be aggregated in a DL transmission. As an example, the reception may be performed by the component 198. FIGS. 7, 10, 11 illustrate an example of the UE 1102 performing such a reception for an aggregation configuration, from a network node (e.g., the base station 1104).

The UE 1102 may be configured to receive, from the base station 1104 (e.g., a network node), an aggregation configuration 1106 that indicates PRS resources (e.g., PRS aggregation 706 in FIG. 7; PRS resource 1004 in FIG. 10). In aspects, the aggregation configuration 1106 may indicate at least two PRS resources (e.g., PRS aggregation 706 in FIG. 7; PRS resource 1004 in FIG. 10) to be aggregated in a DL transmission.

At 1404, the UE receives, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. As an example, the reception may be performed by the component 198. FIGS. 7, 10, 11 illustrate an example of the UE 1102 performing such a reception for an aggregation configuration, from a network node (e.g., the base station 1104).

The UE 1102 may also be configured to receive, from the LMF 1105 (e.g., a network entity) based on the aggregation configuration 1106, at least one pilot signal 1108 via the at least two PRS resources (e.g., PRS aggregation 706 in FIG. 7; PRS resource 1004 in FIG. 10). In aspects, the at least two PRS resources (e.g., PRS aggregation 706 in FIG. 7; PRS resource 1004 in FIG. 10) may be aggregated with a coherency property. A second PRS resource (e.g., PRS resource 1004 in FIG. 10) of the at least two PRS resources (e.g., PRS aggregation 706 in FIG. 7; PRS resource 1004 in FIG. 10) may be associated with a TxTEG identifier (e.g., TxTEG ID in SRS resource 1002 in FIG. 10), in an absence of an assignment of the TxTEG identifier (e.g., TxTEG ID in SRS resource 1002 in FIG. 10) to the second PRS resource (e.g., PRS resource 1004 in FIG. 10), based on assistance information that indicates a first PRS resource (e.g., PRS resource 1004 in FIG. 10) of the at least two PRS resources (e.g., PRS aggregation 706 in FIG. 7; PRS resource 1004 in FIG. 10) is assigned to the TxTEG identifier (e.g., TxTEG ID in SRS resource 1002 in FIG. 10).

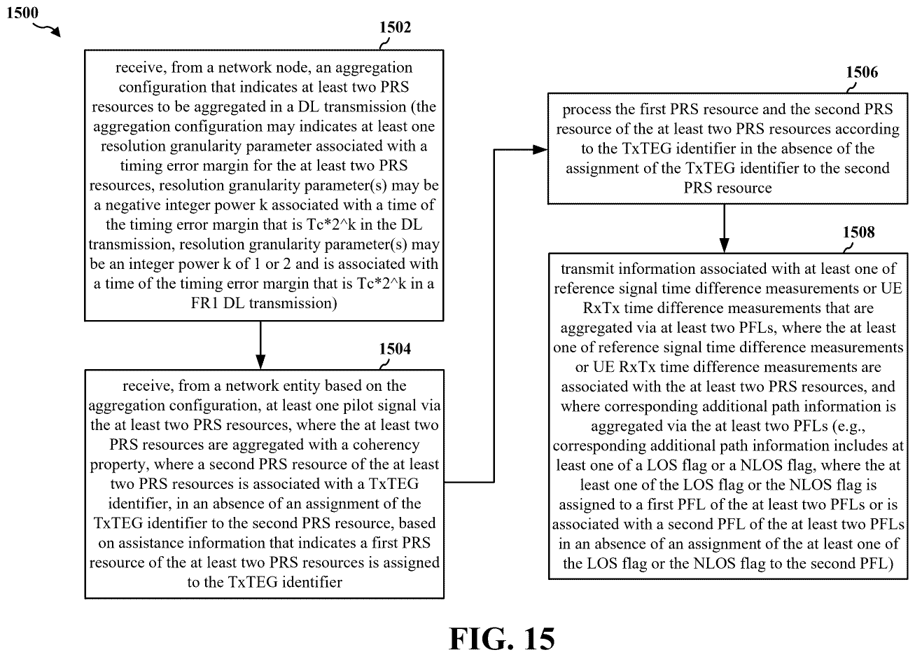

FIG. 15 is a flowchart 1500 of a method of wireless communication, in various aspects. The method may be performed by a UE (e.g., the UE 104, 404, 502, 902, 1102; the apparatus 1604). In some aspects, the method may include aspects described in connection with the communication flow in FIG. 11 and/or aspects described in FIGS. 4-8 and 10. The method provides for PRS aggregation in positioning transmissions that enables a UE to inform a network node (e.g., a base station) and/or a network entity (e.g., an LMF) of coherency status information and to associate characteristics of a PRS resource with other PRS resources aggregated therewith, including intra-band aggregation across CCs, to reduce signaling overhead and RxTx processing (e.g., encoding/decoding).

At 1502, the UE receives, from a network node, an aggregation configuration that indicates at least two PRS resources to be aggregated in a DL transmission. As an example, the reception may be performed by the component 198. FIGS. 7, 10, 11 illustrate an example of the UE 1102 performing such a reception for an aggregation configuration, from a network node (e.g., the base station 1104).

The UE 1102 may be configured to receive, from the base station 1104 (e.g., a network node), an aggregation configuration 1106 that indicates PRS resources (e.g., PRS aggregation 706 in FIG. 7; PRS resource 1004 in FIG. 10). In aspects, the aggregation configuration 1106 may indicate at least two PRS resources (e.g., PRS aggregation 706 in FIG. 7; PRS resource 1004 in FIG. 10) to be aggregated in a DL transmission.

In some aspects, the aggregation configuration 1106 may further indicate at least one resolution granularity parameter or field that may be associated with a timing error margin (e.g., Tx timing error margin in SRS resource 1002, in coherency status indication 1008 in FIG. 10) for the at least two PRS resources (e.g., PRS aggregation 706 in FIG. 7; PRS resource 1004 in FIG. 10). In some such aspects, the resolution granularity parameter or field may be a timing reporting granularity factor (“timingReportingGranularityFactor”) that may specify a recommended reporting granularity for UE Rx-Tx time difference measurements. In some aspects, a ‘Value’ in a range (0 . . . 5) may correspond to (k0 . . . k5) an may be used for a NR UE Rx-Tx time difference (“nr-UE-RxTxTimeDiff”) and/or a NR UE Rx-Tx time difference addition (“nr-UE-RxTxTimeDiffAdditional”) in a NR multi-RTT measurement element (“NR-Multi-RTT-MeasElement’). The UE may select a different granularity value for nr-UE-RxTxTimeDiff and/or nr-UE-RxTxTimeDiffAdditional, in aspects. With respect to report mappings, a reporting range of a base station (e.g., a gNB) Rx-Tx time difference may be defined from −985024*Tc to +985024*Tc. The reporting resolution may be uniform across the reporting range and may be defined as T=Tc*2^{k} (or Tc*2\hat{ }k), where ‘k’ may be selected by the base station from the set {0, 1, 2, 3, 4, 5}. In aspects, the timing constant may be defined as Tc=1/(delta−fmax*Nf) where delta−fmax=480,000 Hz and Nf=4096. In aspects, an LMF may be configured to provide a recommended resolution parameter, timingReportingGranularityFactor, and a base station may be configured to select the parameter ‘k’ based on timingReportingGranularityFactor, after which the base station may inform the LMF of the selection.

In some aspects, the at least one resolution granularity parameter may be extended to include at least one negative integer power for ‘k’ (e.g., −1, −2, . . . , etc.) that may be associated with a time of the timing error margin (e.g., Tx timing error margin in SRS resource 1002, in coherency status indication 1008 in FIG. 10) that is Tc*2^{k} in the DL transmission. That is, ‘k’ may be a negative integer, according to the aspects herein. In some aspects, the at least one resolution granularity parameter may be an integer power ‘k’ of 1 (one) or 2 (two) and may be associated with a time of the timing error margin (e.g., Tx timing error margin in SRS resource 1002, in coherency status indication 1008 in FIG. 10) that is Tc*2^{k} in a FR1 DL transmission. Thus, aspects herein provide configurations for improved granularity for timing reporting, e.g., for receive-transmit time differences, whereby the described techniques can be used to improve precision in timing measurements and/or reporting

At 1504, the UE receives, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. As an example, the reception may be performed by the component 198. FIGS. 7, 10, 11 illustrate an example of the UE 1102 performing such a reception for an aggregation configuration, from a network node (e.g., the base station 1104).

The UE 1102 may also be configured to receive, from the LMF 1105 (e.g., a network entity) based on the aggregation configuration 1106, at least one pilot signal 1108 via the at least two PRS resources (e.g., PRS aggregation 706 in FIG. 7; PRS resource 1004 in FIG. 10). In aspects, the at least two PRS resources (e.g., PRS aggregation 706 in FIG. 7; PRS resource 1004 in FIG. 10) may be aggregated with a coherency property. A second PRS resource (e.g., PRS resource 1004 in FIG. 10) of the at least two PRS resources (e.g., PRS aggregation 706 in FIG. 7; PRS resource 1004 in FIG. 10) may be associated with a TxTEG identifier (e.g., TxTEG ID in SRS resource 1002 in FIG. 10), in an absence of an assignment of the TxTEG identifier (e.g., TxTEG ID in SRS resource 1002 in FIG. 10) to the second PRS resource (e.g., PRS resource 1004 in FIG. 10), based on assistance information that indicates a first PRS resource (e.g., PRS resource 1004 in FIG. 10) of the at least two PRS resources (e.g., PRS aggregation 706 in FIG. 7; PRS resource 1004 in FIG. 10) is assigned to the TxTEG identifier (e.g., TxTEG ID in SRS resource 1002 in FIG. 10).

At 1506, the UE processes the first PRS resource and the second PRS resource of the PRS resources according to a TxTEG identifier in the absence of the assignment of the TxTEG identifier to the second PRS resource. As an example, the reception may be performed by the component 198. FIGS. 7, 10, 11 illustrate an example of the UE 1102 performing such processing for aggregated PRS resources, from a network node (e.g., the base station 1104).

The UE 1102 may be configured to process (at 1110) the first PRS resource (e.g., PRS resource 1004 in FIG. 10) and the second PRS resource (e.g., PRS resource 1004 in FIG. 10) of the at least two PRS resources (e.g., PRS aggregation 706 in FIG. 7; PRS resource 1004 in FIG. 10) according to the TxTEG identifier in the absence of the assignment of the TxTEG identifier to the second PRS resource. In aspects, the first PRS resource (e.g., PRS resource 1004 in FIG. 10) of the at least two PRS resources (e.g., PRS aggregation 706 in FIG. 7; PRS resource 1004 in FIG. 10) may be assigned a timing error margin (e.g., Tx timing error margin in SRS resource 1002, in coherency status indication 1008 in FIG. 10) based on the assistance information, and the second PRS resource (e.g., PRS resource 1004 in FIG. 10) of the at least two PRS resources (e.g., PRS aggregation 706 in FIG. 7; PRS resource 1004 in FIG. 10) may be associated with the timing error margin (e.g., Tx timing error margin in SRS resource 1002, in coherency status indication 1008 in FIG. 10) in an absence of an assignment of the timing error margin (e.g., Tx timing error margin in SRS resource 1002, in coherency status indication 1008 in FIG. 10) to the second PRS resource (e.g., PRS resource 1004 in FIG. 10). In such aspects, the at least two PRS resources (e.g., PRS aggregation 706 in FIG. 7; PRS resource 1004 in FIG. 10) may have a transmission timing mismatch therebetween. In aspects, the first PRS resource (e.g., PRS resource 1004 in FIG. 10) and the second PRS resource (e.g., PRS resource 1004 in FIG. 10) of the at least two PRS resources (e.g., PRS aggregation 706 in FIG. 7; PRS resource 1004 in FIG. 10) may be assigned a timing error margin (e.g., Tx timing error margin in SRS resource 1002, in coherency status indication 1008 in FIG. 10). In such aspects, the first PRS resource (e.g., PRS resource 1004 in FIG. 10) may be aggregated with the second PRS resource (e.g., PRS resource 1004 in FIG. 10), and the first PRS resource (e.g., PRS resource 1004 in FIG. 10) and the second PRS resource (e.g., PRS resource 1004 in FIG. 10) may have a same transmission timing error.

At 1508, the UE transmits measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. As an example, the transmission may be performed by the component 198. The UE 1102 may perform such a transmission for measurement information associated with at least one of reference signal time difference measurements or UE RxTx time difference measurements, for a network node (e.g., the base station 1104) and/or for a network entity (e.g., the LMF 1105).

In aspects, the corresponding additional path information may include at least one of a LOS flag or a NLOS flag, where the at least one of the LOS flag or the NLOS flag is assigned to a first PFL of the at least two PFLs or is associated with a second PFL of the at least two PFLs in an absence of an assignment of the at least one of the LOS flag or the NLOS flag to the second PFL, as illustrated in 1508 of flowchart 1500 in FIG. 15.

The UE 1102 may be configured to transmit measurement information associated with at least one of reference signal time difference measurements or UE reception-transmission (RxTx) time difference measurements that may be aggregated via at least two positioning frequency layers (PFLs). In such aspects, the at least one of reference signal time difference measurements or UE RxTx time difference measurements may be associated with the at least two PRS resources, as described herein, and corresponding additional path information may be aggregated via the at least two PFLs. In some aspects, the corresponding additional path information may include at least one of a line of sight (LOS) flag or a non-line of sight (NLOS) flag. The LOS flag and/or the NLOS flag may be assigned to a first PFL of the at least two PFLs or may be associated with a second PFL of the at least two PFLs in an absence of an assignment of the LOS flag and/or the NLOS flag to the second PFL. Accordingly, by extending associations of characteristics for aggregated resources to aggregations in PFLs, aspects herein may be used to improve RSTD and UE RxTx time difference measurements, as well as to reduce signaling overhead.

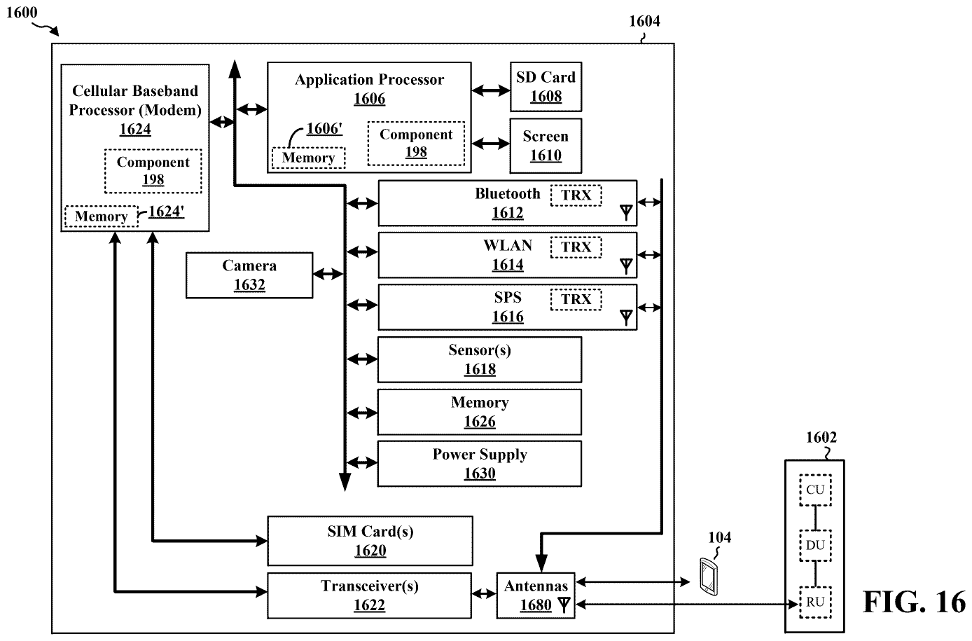

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the component 198 may be configured to receive, from a network node, an aggregation configuration that indicates at least two SRS resources to be aggregated in an UL transmission. The component 198 may be configured to transmit, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. The component 198 may also be configured to transmit at least one additional pilot signal via an additional instance of the at least two SRS resources. The component 198 may be configured to obtain a coherency indication that indicates the additional instance of the at least two SRS resources has a loss of coherency or a maintenance of coherency. The component 198 may be configured to transmit a coherency status indication that includes information associated with the loss of coherency or the maintenance of coherency for the additional instance of the at least two SRS resources. In certain aspects, the component 198 may be configured to receive, from a network node, an aggregation configuration that indicates at least two PRS resources to be aggregated in a DL transmission. The component 198 may be configured to receive, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. The component 198 may also be configured to process the first PRS resource and the second PRS resource of the at least two PRS resources according to the TxTEG identifier in the absence of the assignment of the TxTEG identifier to the second PRS resource. The component 198 may also be configured to transmit measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. The component 198 may be configured to transmit a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. The component 198 may be further configured to perform any of the aspects described in connection with the flowchart in any of FIGS. 12-15, and/or any of the aspects performed by the UE in any of FIGS. 5-11. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include means for receiving, from a network node, an aggregation configuration that indicates at least two SRS resources to be aggregated in an UL transmission. In the configuration, the apparatus 1604, and in particular the cellular baseband processor 1624 and/or the application processor 1606, may also include means for transmitting, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. In one configuration, the apparatus 1604, and in particular the cellular baseband processor 1624 and/or the application processor 1606, may include means for transmitting at least one additional pilot signal via an additional instance of the at least two SRS resources. In one configuration, the apparatus 1604, and in particular the cellular baseband processor 1624 and/or the application processor 1606, may include means for obtaining a coherency indication that indicates the additional instance of the at least two SRS resources has a loss of coherency or a maintenance of coherency. In one configuration, the apparatus 1604, and in particular the cellular baseband processor 1624 and/or the application processor 1606, may include means for transmitting a coherency status indication that includes information associated with the loss of coherency or the maintenance of coherency for the additional instance of the at least two SRS resources. In one configuration, the apparatus 1604, and in particular the cellular baseband processor 1624 and/or the application processor 1606, may include means for receiving, from a network node, an aggregation configuration that indicates at least two PRS resources to be aggregated in a DL transmission. In the configuration, the apparatus 1604, and in particular the cellular baseband processor 1624 and/or the application processor 1606, may include means for receiving, from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. In one configuration, the apparatus 1604, and in particular the cellular baseband processor 1624 and/or the application processor 1606, may include means for processing the first PRS resource and the second PRS resource of the at least two PRS resources according to the TxTEG identifier in the absence of the assignment of the TxTEG identifier to the second PRS resource. In one configuration, the apparatus 1604, and in particular the cellular baseband processor 1624 and/or the application processor 1606, may include means for transmitting measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. In one configuration, the apparatus 1604, and in particular the cellular baseband processor 1624 and/or the application processor 1606, may include means for transmitting a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

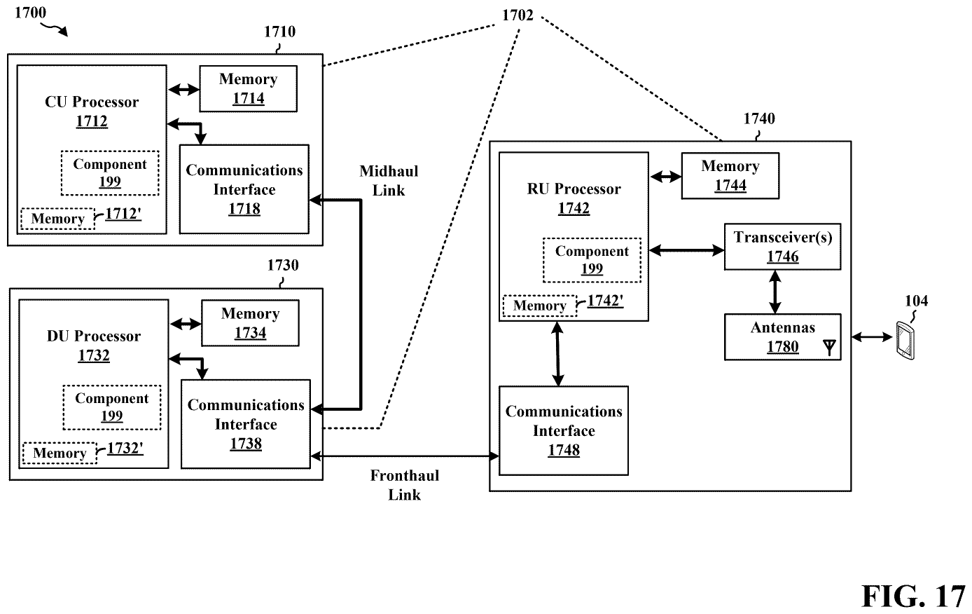

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, an aggregation configuration that indicates at least two SRS resources to be aggregated in an UL transmission. The component 199 may be configured to receive, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. The component 199 may also be configured to receive at least one additional pilot signal via an additional instance of the at least two SRS resources. The component 199 may be configured to receive a coherency status indication that includes information associated with the loss of coherency or the maintenance of coherency for the additional instance of the at least two SRS resources. The component 199 may be configured to receive a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In certain aspects, the component 199 may be configured to transmit, for a UE, an aggregation configuration that indicates at least two PRS resources to be aggregated in a DL transmission. The component 199 may be configured to transmit, as an instance of and from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. The component 199 may also be configured to receive measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. The component 199 may be further configured to perform any of the aspects described in connection with the flowchart in any of FIGS. 12-15, and/or any of the aspects performed by the base station/LMF in any of FIGS. 5-11. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for transmitting, for a UE, an aggregation configuration that indicates at least two SRS resources to be aggregated in an UL transmission. In one configuration, the network entity 1702 may include means for receiving, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. In one configuration, the network entity 1702 may include means for receiving at least one additional pilot signal via an additional instance of the at least two SRS resources. In one configuration, the network entity 1702 may include means for receiving a coherency status indication that includes information associated with the loss of coherency or the maintenance of coherency for the additional instance of the at least two SRS resources. In one configuration, the network entity 1702 may include means for receiving a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In one configuration, the network entity 1702 may include means for transmitting, for a UE, an aggregation configuration that indicates at least two PRS resources to be aggregated in a DL transmission. In one configuration, the network entity 1702 may include means for transmitting, as an instance of and from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. In one configuration, the network entity 1702 may include means for receiving measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

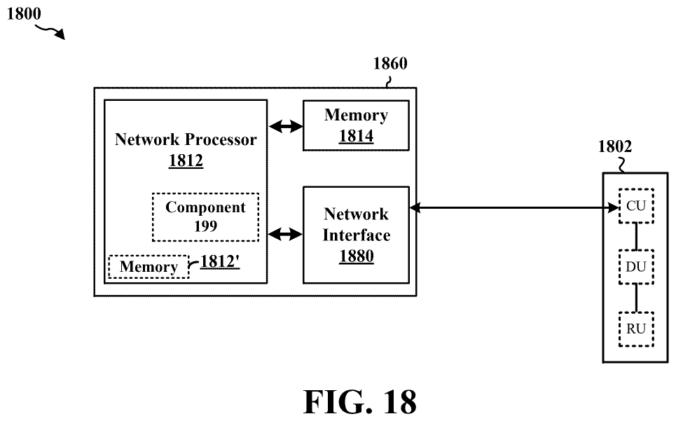

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, an aggregation configuration that indicates at least two SRS resources to be aggregated in an UL transmission. The component 199 may be configured to receive, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. The component 199 may also be configured to receive at least one additional pilot signal via an additional instance of the at least two SRS resources. The component 199 may be configured to receive a coherency status indication that includes information associated with the loss of coherency or the maintenance of coherency for the additional instance of the at least two SRS resources. The component 199 may be configured to receive a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In certain aspects, the component 199 may be configured to transmit, for a UE, an aggregation configuration that indicates at least two PRS resources to be aggregated in a DL transmission. The component 199 may be configured to transmit, as an instance of and from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. The component 199 may also be configured to receive measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. The component 199 may be further configured to perform any of the aspects described in connection with the flowchart in any of FIGS. 12-15, and/or any of the aspects performed by the base station/LMF in any of FIGS. 5-11. The component 199 may be within the processor 1812. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 may include means for transmitting, for a UE, an aggregation configuration that indicates at least two SRS resources to be aggregated in an UL transmission. In one configuration, the network entity 1860 may include means for receiving, based on the aggregation configuration, at least one pilot signal via the at least two SRS resources, where the at least two SRS resources are aggregated with a coherency property in a same set of OFDM symbols, where the at least two SRS resources are associated with at least one of a same pathloss parameter, a same transmit power spectral density, a same spatial relation reference signal, a same comb size, or at least one same time-domain characteristic. In one configuration, the network entity 1860 may include means for receiving at least one additional pilot signal via an additional instance of the at least two SRS resources. In one configuration, the network entity 1860 may include means for receiving a coherency status indication that includes information associated with the loss of coherency or the maintenance of coherency for the additional instance of the at least two SRS resources. In one configuration, the network entity 1860 may include means for receiving a TxTEG identifier assigned to a first SRS resource of the at least two SRS resources, where a second SRS resource of the at least two SRS resources is associated with the TxTEG identifier in an absence of an assignment of the TxTEG identifier to the second SRS resource. In one configuration, the network entity 1860 may include means for transmitting, for a UE, an aggregation configuration that indicates at least two PRS resources to be aggregated in a DL transmission. In one configuration, the network entity 1860 may include means for transmitting, as an instance of and from a network entity based on the aggregation configuration, at least one pilot signal via the at least two PRS resources, where the at least two PRS resources are aggregated with a coherency property, where a second PRS resource of the at least two PRS resources is associated with a TxTEG identifier, in an absence of an assignment of the TxTEG identifier to the second PRS resource, based on assistance information that indicates a first PRS resource of the at least two PRS resources is assigned to the TxTEG identifier. In one configuration, the network entity 1860 may include means for receiving measurement information associated with at least one of reference signal time difference measurements or UE RxTx time difference measurements that are aggregated via at least two PFLs, where the at least one of reference signal time difference measurements or UE RxTx time difference measurements are associated with the at least two PRS resources, and where corresponding additional path information is aggregated via the at least two PFLs. The means may be the component 199 of the network entity 1860 configured to perform the functions recited by the means.

Wireless communication networks may enable positioning measurements and operations to locate wireless devices. A wireless communication network may utilize pilot signals transmitted via SRS resources and/or PRS resources that may have characteristics such as transmission timing error group (TxTEG) identifiers, transmission timing error margins, transmission timing errors, etc. To improve efficiency in positioning measurements and operations, reference signal resources may be aggregated for transmissions. However, coherency for transmissions of aggregated reference signal resources may affect accuracy in positioning information and operations. A UE may not be aware of a loss of coherency for aggregated reference signal resources until after the transmission via aggregated reference signal resources has occurred. Thus, accuracy for timing and positioning at the network side may be impacted. Moreover, signaling overhead for reference signal resource characteristics (e.g., TxTEG identifiers, transmission timing error margins, transmission timing errors, etc.) may include additional processing (e.g., encoding/decoding) and power consumption for transmitters and receivers.

The described aspects for positioning operations for wireless devices, e.g., for aggregation of SRS and PRS resources in positioning transmissions, enable wireless devices to more efficiently signal positioning information via aggregation, coherency reporting, and association of reference signaling resource characteristics. In one example, a UE may receive an aggregation configuration that indicates at least two SRS resources to be aggregated in an UL transmission, and may transmit, based on the aggregation configuration, at least one pilot signal via the at least two SRS resources. The at least two SRS resources may be aggregated with a coherency property in a same set of OFDM symbols, and the at least two SRS resources may be associated with at least one of a same pathloss parameter, a same transmit power spectral density, a same spatial relation reference signal, a same comb size, or at least one same time-domain characteristic. The pathloss parameter may be associated with a cross-CC pathloss reference indication, and the at least two SRS resources may be transmitted with the cross-CC pathloss reference indication, the same pathloss parameter may be associated with a CC with a lowest CC index, and/or the same pathloss parameter may be associated with a CC that is a Pcell for the UE. In another example, a UE may receive, from a network node, an aggregation configuration that indicates at least two PRS resources to be aggregated in a DL transmission, and may receive, from a network entity (e.g., a location management function (LMF)) based on the aggregation configuration, at least one pilot signal via the at least two PRS resources. The at least two PRS resources may be aggregated with a coherency property, and a second PRS resource of the at least two PRS resources may be associated with a TxTEG identifier, in an absence of an assignment of the TxTEG identifier to the second PRS resource, based on assistance information that indicates a first PRS resource of the at least two PRS resources is assigned to the TxTEG identifier.

In some examples, by reporting coherency status information for aggregated reference signal resources and associating TxTEG identifiers and timing error margins to unassigned or untagged reference signal resources, the described techniques can be used to more efficiently transmit signals on reference signal resources, improving bandwidth (e.g., two aggregated resources of equal size effectively double the transmission bandwidth) and supporting cross-CC pathloss reference indications for intra-band aggregation, while reducing signaling overhead for TxTEG identifiers and timing error margins, as well as providing network nodes (e.g., base stations) and network entities (e.g., LMFs) coherency status information via indications for aggregated reference signal resources maintaining and/or losing coherency. Additionally, by providing configurations for improved granularity for timing reporting, e.g., for receive-transmit time differences, the described techniques can be used to improve precision in timing measurements/reporting, and by extending associations of characteristics for aggregated resources to aggregations in PFLs, the described techniques can be used to improve RSTD and UE RxTx time difference measurements and reduce signaling overhead.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: receiving, from a network node, an aggregation configuration that indicates at least two sounding reference signal (SRS) resources to be aggregated in an uplink (UL) transmission; and transmitting, based on the aggregation configuration, at least one pilot signal via the at least two SRS resources, where the at least two SRS resources are aggregated with a coherency property in a same set of orthogonal frequency division multiplexing (OFDM) symbols, where the at least two SRS resources are associated with at least one of a same pathloss parameter, a same transmit power spectral density, a same spatial relation reference signal, a same comb size, or at least one same time-domain characteristic.

Aspect 2 is the method of aspect 1, where the same pathloss parameter is associated with a cross-component carrier (CC) pathloss reference indication, and where transmitting the at least two SRS resources includes transmitting the at least two SRS resources with the cross-CC pathloss reference indication; where the same pathloss parameter is associated with a CC with a lowest CC index; and/or where the same pathloss parameter may be associated with a CC that is a Pcell for the UE.

Aspect 3 is the method of any of aspects 1 and 2, further including: transmitting an additional instance of the at least two SRS resources; obtaining a coherency indication that indicates the additional instance of the at least two SRS resources has a loss of coherency or a maintenance of coherency; and transmitting a coherency status indication that includes information associated with the loss of coherency or the maintenance of coherency for the additional instance of the at least two SRS resources.

Aspect 4 is the method of aspect 3, where transmitting the coherency status indication is in association with an uplink time difference of arrival (U-TDOA) and includes transmitting, for the network node via radio resource control (RRC) signaling, the coherency status indication in an information element (IE) for UE positioning assistance information; or where the UE is associated with multi-round trip time (M-RTT) positioning, where transmitting the coherency status indication includes transmitting, for a location management function (LMF) via long term evolution (LTE) positioning protocol (LPP) signaling, the coherency status indication in new radio (NR) M-RTT signal measurement information.

Aspect 5 is the method of aspect 4, where transmitting the coherency status indication includes at least one of: the coherency status indication as at least one of a standalone transmission or periodic transmissions; the coherency status indication including a transmission timestamp associated with the loss of coherency or the maintenance of coherency for the at least two SRS resources; or the coherency status indication including error margin information associated with at least one first transmission timing error margin between the at least two SRS resources.

Aspect 6 is the method of aspect 5, where the at least one first transmission timing error margin between the at least two SRS resources is equivalent to at least one second transmission timing error margin associated with a transmission timing error group (TxTEG) identifier assigned to a first SRS resource of the at least two SRS resources or is a subset of the at least one second transmission timing error margin, where the at least one first transmission timing error margin includes a tc0 enumeration.

Aspect 7 is the method of any of aspects 1 to 6, further including: transmitting a transmission timing error group (TxTEG) identifier assigned to the first SRS resource of the at least two SRS resources, where a second SRS resource of the at least two SRS resources is associated with the TxTEG identifier in an absence of an assignment of the TxTEG identifier to the second SRS resource.

Aspect 8 is the method of aspect 7, where transmitting the TxTEG identifier includes transmitting at least one transmission timing error margin assigned to the first SRS resource of the at least two SRS resources, where the second SRS resource of the at least two SRS resources is associated with the at least one transmission timing error margin in an absence of an assignment of the at least one transmission timing error margin to the second SRS resource, where the at least two SRS resources have a transmission timing mismatch therebetween.

Aspect 9 is the method of aspect 7, where transmitting the TxTEG identifier includes transmitting a transmission timing error margin assigned to the first SRS resource and the second SRS resource of the at least two SRS resources, where the first SRS resource is aggregated with the second SRS resource, where the first SRS resource and the second SRS resource have a same transmission timing error.

Aspect 10 is the method of aspect 9, where transmitting, for the network node based on the aggregation configuration, the at least one pilot signal via the at least two SRS resources includes transmitting, for the network node based on the aggregation configuration, at least one additional pilot signal via at least one additional SRS resource, where the at least one additional SRS resource is assigned an additional TxTEG identifier that is different from the TxTEG identifier, and where the at least one additional SRS resource is assigned an additional transmission timing error margin that is greater than the transmission timing error margin.

Aspect 11 is the method of aspect 10, where the first SRS resource and the second SRS resource are assigned a phase error group (PEG) identifier that is different from an additional PEG identifier assigned to the at least one additional SRS resource.

Aspect 12 is a method of wireless communication at a user equipment (UE), including: receiving, from a network node, an aggregation configuration that indicates at least two positioning reference signal (PRS) resources to be aggregated in a downlink (DL) transmission; and receiving, from a network entity based on the aggregation configuration, at least one pilot signal via the at least two PRS resources, where the at least two PRS resources are aggregated with a coherency property, where a second PRS resource of the at least two PRS resources is associated with a transmission timing error group (TxTEG) identifier, in an absence of an assignment of the TxTEG identifier to the second PRS resource, based on assistance information that indicates a first PRS resource of the at least two PRS resources is assigned to the TxTEG identifier.

Aspect 13 is the method of aspect 12, further including: processing the first PRS resource and the second PRS resource of the at least two PRS resources according to the TxTEG identifier in the absence of the assignment of the TxTEG identifier to the second PRS resource.

Aspect 14 is the method of any of aspects 12 and 13, where the first PRS resource of the at least two PRS resources is assigned a timing error margin based on the assistance information, where the second PRS resource of the at least two PRS resources is associated with the timing error margin in an absence of an assignment of the timing error margin to the second PRS resource, where the at least two PRS resources have a transmission timing mismatch therebetween.

Aspect 15 is the method of any of aspects 12 and 13, where the first PRS resource and the second PRS resource of the at least two PRS resources is assigned a timing error margin, where the first PRS resource is aggregated with the second PRS resource, where the first PRS resource and the second PRS resource have a same transmission timing error.

Aspect 16 is the method of aspect 15, where receiving, from the network node based on the aggregation configuration, the at least one pilot signal via the at least two PRS resources includes receiving, from the network node based on the aggregation configuration, at least one additional pilot signal via at least one additional PRS resource, where the at least one additional PRS resource is assigned an additional TxTEG identifier that is different from the TxTEG identifier, and where the at least one additional PRS resource is assigned an additional timing error margin that is greater than the timing error margin.

Aspect 17 is the method of aspect 16, where the first PRS resource and the second PRS resource are assigned a phase error group (PEG) identifier that is different from an additional PEG identifier assigned to the at least one additional PRS resource.

Aspect 18 is the method of any of aspects 12 to 17, where the aggregation configuration further indicates at least one resolution granularity parameter associated with a timing error margin for the at least two PRS resources; where the at least one resolution granularity parameter is a negative integer power k associated with a time of the timing error margin that is Tc*2\hat{ }k in the DL transmission; or where the at least one resolution granularity parameter is an integer power k of 1 or 2 and is associated with a time of the timing error margin that is Tc*2\hat{ }k in a frequency range 1 (FR1) DL transmission.

Aspect 19 is the method of any of aspects 12 to 18, further including: transmitting measurement information associated with at least one of reference signal time difference measurements or UE reception-transmission (RxTx) time difference measurements that are aggregated via at least two positioning frequency layers (PFLs), where the at least one of reference signal time difference measurements or UE RxTx time difference measurements are associated with the at least two PRS resources, and where corresponding additional path information is aggregated via the at least two PFLs.

Aspect 20 is the method of aspect 19, where the corresponding additional path information includes at least one of a line of sight (LOS) flag or a non-line of sight (NLOS) flag, where the at least one of the LOS flag or the NLOS flag is assigned to a first PFL of the at least two PFLs or is associated with a second PFL of the at least two PFLs in an absence of an assignment of the at least one of the LOS flag or the NLOS flag to the second PFL.

Aspect 21 is an apparatus for wireless communication including means for implementing any of aspects 1 to 11.

Aspect 22 is a computer-readable medium (e.g., a non-transitory computer-readable medium) storing computer executable code, the code when executed by at least one processor causes the at least one processor to implement any of aspects 1 to 11.

Aspect 23 is an apparatus for wireless communication at a network node. The apparatus includes a memory; and at least one processor coupled to the memory and, based at least in part on information stored in the memory, the at least one processor is configured to implement any of aspects 1 to 11.

Aspect 24 is the apparatus of aspect 23, further including at least one of a transceiver or an antenna coupled to the at least one processor.

Aspect 25 is an apparatus for wireless communication including means for implementing any of aspects 12 to 20.

Aspect 26 is a computer-readable medium (e.g., a non-transitory computer-readable medium) storing computer executable code, the code when executed by at least one processor causes the at least one processor to implement any of aspects 12 to 20.

Aspect 27 is an apparatus for wireless communication at a network node. The apparatus includes a memory; and at least one processor coupled to the memory and, based at least in part on information stored in the memory, the at least one processor is configured to implement any of aspects 12 to 20.

Aspect 28 is the apparatus of aspect 25, further including at least one of a transceiver or an antenna coupled to the at least one processor.

Aspect 29 is a method of wireless communication at a user equipment (UE), including: receiving an aggregation configuration that indicates at least one resolution granularity parameter associated with a timing error margin for at least two PRS resources, where the at least one resolution granularity parameter is a negative integer power k associated with a time of the timing error margin that is Tc*2\hat{ }k in the DL transmission or where the at least one resolution granularity parameter is an integer power k of 1 or 2 and is associated with a time of the timing error margin that is Tc*2\hat{ }k in a frequency range 1 (FR1) DL transmission; and at least one of: receiving, from a network entity based on the aggregation configuration, at least one pilot signal via the at least two PRS resources, where the at least two PRS resources are aggregated based on the timing error margin; or processing a first PRS resource and a second PRS resource of the at least two PRS resources according to the at least one resolution granularity parameter associated with a timing error margin.

Aspect 30 is an apparatus for wireless communication including means for implementing aspect 29.

Aspect 31 is a computer-readable medium (e.g., a non-transitory computer-readable medium) storing computer executable code, the code when executed by at least one processor causes the at least one processor to implement aspect 29.

Aspect 32 is an apparatus for wireless communication at a network node. The apparatus includes a memory; and at least one processor coupled to the memory and, based at least in part on information stored in the memory, the at least one processor is configured to implement aspect 29.

Aspect 33 is the apparatus of aspect 32, further including at least one of a transceiver or an antenna coupled to the at least one processor.

Aspect 34 is a method of wireless communication at a user equipment (UE), including: transmitting measurement information associated with at least one of reference signal time difference measurements or UE reception-transmission (RxTx) time difference measurements that are aggregated via at least two positioning frequency layers (PFLs), where the at least one of reference signal time difference measurements or UE RxTx time difference measurements are associated with the at least two PRS resources, and where corresponding additional path information is aggregated via the at least two PFLs.

Aspect 35 is the method of aspect 34, where the corresponding additional path information includes at least one of a line of sight (LOS) flag or a non-line of sight (NLOS) flag, where the at least one of the LOS flag or the NLOS flag is assigned to a first PFL of the at least two PFLs or is associated with a second PFL of the at least two PFLs in an absence of an assignment of the at least one of the LOS flag or the NLOS flag to the second PFL.

Aspect 36 is an apparatus for wireless communication including means for implementing any of aspects 34 and 35.

Aspect 37 is a computer-readable medium (e.g., a non-transitory computer-readable medium) storing computer executable code, the code when executed by at least one processor causes the at least one processor to implement any of aspects 34 and 35.

Aspect 38 is an apparatus for wireless communication at a network node. The apparatus includes a memory; and at least one processor coupled to the memory and, based at least in part on information stored in the memory, the at least one processor is configured to implement any of aspects 34 and 35.

Aspect 39 is the apparatus of aspect 38, further including at least one of a transceiver or an antenna coupled to the at least one processor.

1. An apparatus for wireless communication at a user equipment (UE),
comprising: a memory; and
at least one processor coupled to the memory and, based at least in part on information stored in the memory, the at least one processor is configured to:
receive, from a network node, an aggregation configuration that indicates at least two sounding reference signal (SRS) resources to be aggregated in an uplink (UL) transmission; and
transmit, based on the aggregation configuration, at least one pilot signal via the at least two SRS resources, wherein the at least two SRS resources are aggregated with a coherency property in a same set of orthogonal frequency division multiplexing (OFDM) symbols, wherein the at least two SRS resources are associated with at least one of a same pathloss parameter, a same transmit power spectral density, a same spatial relation reference signal, a same comb size, or at least one same time-domain characteristic.

2. The apparatus of claim 1, wherein the same pathloss parameter is associated with a cross-component carrier (CC) pathloss reference indication, and wherein to transmit the at least two SRS resources, the at least one processor is configured to transmit the at least two SRS resources with the cross-CC pathloss reference indication;
wherein the same pathloss parameter is associated with a CC with a lowest CC index; or
wherein the same pathloss parameter is associated with a CC that is a primary cell (Pcell) for the UE.

3. The apparatus of claim 1, wherein the at least one processor is further configured to:
transmit at least one additional pilot signal via an additional instance of the at least two SRS resources;
obtain a coherency indication that indicates the additional instance of the at least two SRS resources has a loss of coherency or a maintenance of coherency; and
transmit a coherency status indication that includes information associated with the loss of coherency or the maintenance of coherency for the additional instance of the at least two SRS resources.

4. The apparatus of claim 3, wherein to transmit the coherency status indication, the at least one processor is configured to transmit the coherency status indication in association with an uplink time difference of arrival (U-TDOA) and transmit, for the network node via radio resource control (RRC) signaling, the coherency status indication in an information element (IE) for UE positioning assistance information; or wherein the UE is associated with multi-round trip time (M-RTT) positioning, wherein to transmit the coherency status indication, the at least one processor is configured to transmit, for a location management function (LMF) via long term evolution (LTE) positioning protocol (LPP) signaling, the coherency status indication in new radio (NR) M-RTT signal measurement information.

5. The apparatus of claim 4, wherein to transmit the coherency status indication, the at least one processor is configured to transmit at least one of:
the coherency status indication as at least one of a standalone transmission or periodic transmissions;
the coherency status indication that includes a transmission timestamp associated with the loss of coherency or the maintenance of coherency for the at least two SRS resources; or
the coherency status indication that includes error margin information associated with at least one first transmission timing error margin between the at least two SRS resources.

6. The apparatus of claim 5, wherein the at least one first transmission timing error margin between the at least two SRS resources is equivalent to at least one second transmission timing error margin associated with a transmission timing error group (TxTEG) identifier assigned to a first SRS resource of the at least two SRS resources or is a subset of the at least one second transmission timing error margin, wherein the at least one first transmission timing error margin includes a tc0 enumeration.

7. The apparatus of claim 1, wherein the at least one processor is further configured to: transmit a transmission timing error group (TxTEG) identifier assigned to a first SRS resource of the at least two SRS resources, wherein a second SRS resource of the at least two SRS resources is associated with the TxTEG identifier in an absence of an assignment of the TxTEG identifier to the second SRS resource.

8. The apparatus of claim 7, wherein to transmit the TxTEG identifier, the at least one processor is configured to transmit at least one transmission timing error margin assigned to the first SRS resource of the at least two SRS resources, wherein the second SRS resource of the at least two SRS resources is associated with the at least one transmission timing error margin in an absence of an assignment of the at least one transmission timing error margin to the second SRS resource, wherein the at least two SRS resources have a transmission timing mismatch therebetween.

9. The apparatus of claim 7, wherein to transmit the TxTEG identifier, the at least one processor is configured to transmit a transmission timing error margin assigned to the first SRS resource and the second SRS resource of the at least two SRS resources, wherein the first SRS resource is aggregated with the second SRS resource, wherein the first SRS resource and the second SRS resource have a same transmission timing error.

10. The apparatus of claim 9, wherein to transmit, based on the aggregation configuration, the at least one pilot signal via the at least two SRS resources, the at least one processor is configured to transmit, based on the aggregation configuration, at least one additional pilot signal via at least one additional SRS resource, wherein the at least one additional SRS resource is assigned an additional TxTEG identifier that is different from the TxTEG identifier, and wherein the at least one additional SRS resource is assigned an additional transmission timing error margin that is greater than the transmission timing error margin.

11. The apparatus of claim 10, wherein the first SRS resource and the second SRS resource are assigned a phase error group (PEG) identifier that is different from an additional PEG identifier assigned to the at least one additional SRS resource.

12. An apparatus for wireless communication at a user equipment (UE), comprising: a memory; and
at least one processor coupled to the memory and, based at least in part on information stored in the memory, the at least one processor is configured to:
receive, from a network node, an aggregation configuration that indicates at least two positioning reference signal (PRS) resources to be aggregated in a downlink (DL) transmission; and
receive, from a network entity based on the aggregation configuration, at least one pilot signal via the at least two PRS resources, wherein the at least two PRS resources are aggregated with a coherency property, wherein a second PRS resource of the at least two PRS resources is associated with a transmission timing error group (TxTEG) identifier, in an absence of an assignment of the TxTEG identifier to the second PRS resource, based on assistance information that indicates a first PRS resource of the at least two PRS resources is assigned to the TxTEG identifier.

13. The apparatus of claim 12, wherein the at least one processor is further configured to:
process the first PRS resource and the second PRS resource of the at least two PRS resources according to the TxTEG identifier in the absence of the assignment of the TxTEG identifier to the second PRS resource.

14. The apparatus of claim 12, wherein the first PRS resource of the at least two PRS resources is assigned a timing error margin based on the assistance information, wherein the second PRS resource of the at least two PRS resources is associated with the timing error margin in an absence of an assignment of the timing error margin to the second PRS resource, wherein the at least two PRS resources have a transmission timing mismatch therebetween.

15. The apparatus of claim 12, wherein the first PRS resource and the second PRS resource of the at least two PRS resources is assigned a timing error margin, wherein the first PRS resource is aggregated with the second PRS resource, wherein the first PRS resource and the second PRS resource have a same transmission timing error.

16-17. (canceled)

18. The apparatus of claim 12, wherein the aggregation configuration further indicates at least one resolution granularity parameter associated with a timing error margin for the at least two PRS resources;
wherein the at least one resolution granularity parameter is a negative integer power k associated with a time of the timing error margin that is Tc*2Ak in the DL transmission; or
wherein the at least one resolution granularity parameter is an integer power k of 1 or 2 and is associated with a time of the timing error margin that is Tc*2Ak in a frequency range 1 (FR1) DL transmission.

19. The apparatus of claim 12, wherein the at least one processor is further configured to:
transmit measurement information associated with at least one of reference signal time difference measurements or UE reception-transmission (RxTx) time difference measurements that are aggregated via at least two positioning frequency layers (PFLs), wherein at least one of the reference signal time difference measurements or the LTE RxTx time difference measurements are associated with the at least two PRS resources, and wherein corresponding additional path information is aggregated via the at least two PFLs.

20. (canceled)

21. A method of wireless communication at a user equipment (UE), comprising:
receiving, from a network node, an aggregation configuration that indicates at least two sounding reference signal (SRS) resources to be aggregated in an uplink (UL) transmission; and
transmitting, based on the aggregation configuration, at least one pilot signal via the at least two SRS resources, wherein the at least two SRS resources are aggregated with a coherency property in a same set of orthogonal frequency division multiplexing (OFDM) symbols, wherein the at least two SRS resources are associated with at least one of a same pathloss parameter, a same transmit power spectral density a same spatial relation reference signal, a same comb size, or at least one same time-domain characteristic.

22. The method of claim 21, wherein the same pathloss parameter is associated with a cross-component carrier (CC) pathloss reference indication, and wherein transmitting the at least two SRS resources includes transmitting the at least two SRS resources with the cross-CC pathloss reference indication;
wherein the same pathloss parameter is associated with a CC with a lowest CC index; or
wherein the same pathloss parameter is associated with a CC that is a primary cell (Pcell) for the UE.

23. The method of claim 21, further comprising:
transmitting an additional instance of the at least two SRS resources; obtaining a coherency indication that indicates the additional instance of the at least two SRS resources has a loss of coherency or a maintenance of coherency; and transmitting a coherency status indication that includes information associated with the loss of coherency or the maintenance of coherency for the additional instance of the at least two SRS resources.

24-30. (canceled)
